(19) United States
(12) Patent Application Publication
(10) Pub. No.: US 2024/0414765 A1
(43) Pub. Date: Dec. 12, 2024

(54) MEASUREMENT SCALING FOR MEASUREMENT GAP IN A NON-TERRESTRIAL NETWORK

(71) Applicant: Telefonaktiebolaget LM Ericsson (publ), Stockholm (SE)

(72) Inventors: Ming LI, Stockholm (SE); Zhixun TANG, Beijing (CN)

(21) Appl. No.: 18/702,439

(22) PCT Filed: Oct. 21, 2022
(86) PCT No.: PCT/SE2022/050960

§ 371 Date: Apr. 18, 2024

(30) Foreign Application Priority Data
Oct. 22, 2021 (WO) PCT/CN2021/125534

(51) Int. Cl. H04W 74/0816; H04W 8/22; H04W 84/06

(52) U.S. Cl. CPC H04W 74/0816; H04W 8/22; H04W 84/06

(57) ABSTRACT

A method in a wireless device WD is described. The WD is configured to communicate with a network node. The method includes determining a scaling factor for at least one measurement gap (MG) in at least one measurement gap pattern (MGP), where the scaling factor is based on at least one of network information and a WD capability; performing a measurement associated with the at least one MG on received signaling based on the determined scaling factor, where the received signaling includes the at least one MG in the at least one MGP; and transmitting information about the measurement.

### TECHNICAL FIELD

The present disclosure relates to wireless communications, and in particular, to measurements scaling for measurement gap in a non-terrestrial network (NTN).

### BACKGROUND

There is an ongoing resurgence of satellite communications. Several plans for satellite networks have been announced in the past few years. Satellite networks could complement mobile networks on the ground by providing connectivity to underserved areas and multicast/broadcast services.

To benefit from the strong mobile ecosystem and economy of scale, adapting the terrestrial wireless access technologies including 3rd Generation Partnership Project (3GPP) Long Term Evolution (LTE) and 3GPP New Radio (NR, also called 5th Generation or 5G) for satellite networks is drawing significant interest, which has been reflected in the 3GPP standardization work.

In 3GPP Release 15, the first release of the 5G system (5GS) was specified. This is a new generation radio access technology (RAT) intended to serve use cases such as enhanced mobile broadband (eMBB), ultra-reliable and low latency communication (URLLC), and mMTC. 5G includes the New Radio (NR) access stratum interface and the 5G Core Network (5GC). The NR physical and higher layers are reusing parts of the LTE specification, and to that add needed components when motivated by new use cases. One such component is the introduction of a sophisticated framework for beam forming and beam management to extend the support of the 3GPP technologies to a frequency range going beyond 6 GHz.

Further, in 3GPP Release 15, 3GPP started the work to prepare NR for operation in a Non-Terrestrial Network (NTN). The work was performed within the study item “NR to support Non-Terrestrial Networks” and resulted in 3GPP Technical Report (TR) 38.811. In 3GPP Release 16, the work to prepare NR for operation in an NTN network continued with the study item “Solutions for NR to support Non-Terrestrial Network”. In parallel, the interest to adapt Narrowband Internet of Things (NB-IoT) and LTE Machine (LTE-M) for operation in NTN has been growing. As a consequence, 3GPP Release 17 includes a work item on NR NTN and a study item on NB-IoT and LTE-M support for NTN.

Example NTN Characteristics may include

A satellite radio access network usually includes the following components:
A satellite that refers to a space-borne platform.
An earth-based gateway that connects the satellite to a base station or a core network, depending on the choice of architecture.
Feeder link that refers to the link between a gateway and a satellite.
Access link, or service link, that refers to the link between a satellite and a wireless device (WD, also called User equipment or UE).

Depending on the orbit altitude, a satellite may be categorized as low earth orbit (LEO), medium earth orbit (MEO), or geostationary earth orbit (GEO) satellite.
LEO: typical heights ranging from 250-1,500 km, with orbital periods ranging from 90-120 minutes.
MEO: typical heights ranging from 5,000-25,000 km, with orbital periods ranging from 3-15 hours.
GEO: height at about 35,786 km, with an orbital period of 24 hours.

Two basic architectures can be distinguished for satellite communication networks, depending on the functionality of the satellites in the system:
Transparent payload (also referred to as bent pipe architecture). The satellite forwards the received signal between the terminal and the network equipment on the ground with only amplification and a shift from uplink frequency to downlink frequency. When applied to general 3GPP architecture and terminology, the transparent payload architecture means that the network node (e.g., gNB) is located on the ground and the satellite forwards signals/data between the network node (e.g., gNB) and the WD.
Regenerative payload. The satellite includes on-board processing to demodulate and decode the received signal and regenerate the signal before sending it back to the earth. When applied to general 3GPP architecture and terminology, the regenerative payload architecture means that the network node (e.g., gNB) is located in the satellite.

In the work item for NR NTN in 3GPP Release 17, only the transparent payload architecture is considered.

A satellite network or satellite based mobile network may also be called as non-terrestrial network (NTN). On the other hand, a mobile network with base stations on the group may also be called as terrestrial network (TN) or non-NTN network. A satellite within NTN may be called as NTN node, NTN satellite or simply a satellite. FIG. 1 shows an example architecture of a satellite network with bent pipe transponders (i.e. the transparent payload architecture).

A communication satellite typically generates several beams over a given area. The footprint of a beam is usually in an elliptic shape, which has traditionally been considered as a cell. However, cells consisting of the coverage footprint of multiple beams are not excluded in the 3GPP work. The footprint of a beam is also often referred to as a spotbeam. The footprint of a beam may move over the earth's surface with the satellite movement or may be earth fixed with a beam pointing mechanism used by the satellite to compensate for the satellite's motion. The size of a spotbeam depends on the system design, which may range from tens of kilometers to a few thousands of kilometers.

In a LEO or MEO communication system, a large number of satellites deployed over a range of orbits are required to provide continuous coverage across the full globe. Launching a mega satellite constellation is both an expensive and time-consuming procedure. It is therefore expected that all LEO and MEO satellite constellations for some time will only provide partial earth-coverage. In case of some constellations dedicated to massive IoT services with relaxed latency requirements, it may not even be necessary to support full earth-coverage. It may be sufficient to provide occasional or periodic coverage according to the orbital period of the constellation.

A 3GPP device in an operation mode or connection state (e.g., RRC_IDLE or RRC_INACTIVE state) may be required to perform various procedures including measurements for mobility purposes, paging monitoring, logging measurement results, tracking area update, and search for a new public land mobile network (PLMN), etc. However, these procedures may consume power in devices. A general trend in 3GPP has been to allow for relaxation of these procedures to prolong device battery life. This trend has been especially pronounced for IoT devices supported by reduced capability (redcap), NB-IoT and LTE-M.

In addition, propagation delay is an important aspect of satellite communications that is different from the delay expected in a terrestrial mobile system. For a bent pipe satellite network, the round-trip delay may, depending on the orbit height, range from tens of ms in the case of LEO satellites to several hundreds of ms for GEO satellites. As a comparison, the round-trip delays in terrestrial cellular networks are typically below 1 ms.

The distance between the WD and a satellite can vary significantly, depending on the position of the satellite and thus the elevation angle F seen by the WD. Assuming circular orbits, the minimum distance is realized when the satellite is directly above the WD (ε=90°), and the maximum distance when the satellite is at the smallest possible elevation angle. Table 1 shows the distances between satellite and WD for different orbital heights and elevation angles together with the one-way propagation delay and the maximum propagation delay difference (the difference from the propagation delay at ε=90°). Note that this table assumes regenerative payload architecture. For the transparent payload case, the propagation delay between gateway and satellite needs to be considered as well, unless the base station corrects for that.

TABLE 1
Propagation delay for different orbital heights and elevation angles.

| | | | | | One-way | | Propagation |
|---|---|---|---|---|---|---|---|
| Orbital | | Elevation | Distance | | propagation | | delay |
| height | | angle | WD <−> satellite | | delay | | difference |
| 600 | km | 90° | 600 | km | 2.0 | ms | — |

| | | | | | | |
|---|---|---|---|---|---|---|
| 30° | 1075 | km | 3.6 | ms | 1.6 | ms |
| 10° | 1932 | km | 6.4 | ms | 4.4 | ms |

| | | | | | | | |
|---|---|---|---|---|---|---|---|
| 1200 | km | 90° | 1200 | km | 4.0 | ms | — |

| | | | | | | |
|---|---|---|---|---|---|---|
| 30° | 1999 | km | 6.7 | ms | 2.7 | ms |
| 10° | 3131 | km | 10.4 | ms | 6.4 | ms |

| | | | | | | | |
|---|---|---|---|---|---|---|---|
| 35786 | km | 90° | 35786 | km | 119.4 | ms | — |

| | | | | | | |
|---|---|---|---|---|---|---|
| 30° | 38609 | km | 128.8 | ms | 9.4 | ms |
| 10° | 40581 | km | 135.4 | ms | 16.0 | ms |

The propagation delay may also be highly variable due to the high velocity of the LEO and MEO satellites and change in the order of 10-100 μs every second, depending on the orbit altitude and satellite velocity.

### SSB-MTC and Measurement Gaps

NR synchronization signal (SS) may consist of primary SS (PSS) and secondary SS (SSS). NR physical broadcast channel (PBCH) carries the very basic system information. The combination of SS and PBCH is referred to as SSB in NR. Multiple SSBs are transmitted in a localized burst set. Within an SS burst set, multiple SSBs can be transmitted in different beams. The transmission of SSBs within a localized burst set may be confined to a 5 ms window. The set of possible SSB time locations within an SS burst set may depend on the numerology which in most cases is uniquely identified by the frequency band. The SSB periodicity can be configured from the value set {5, 10, 20, 40, 80, 160} ms (where the unit used in the configuration is subframe, which has a duration of 1 ms).

A WD does not need to perform measurements with the same periodicity as the SSB periodicity. Accordingly, the SSB measurement time configuration (SMTC) has been introduced for NR. The signaling of SMTC window informs the WD of the timing and periodicity of SSBs that the WD can use for measurements. The SMTC window periodicity can be configured from the value set {5, 10, 20, 40, 80, 160} ms, matching the possible SSB periodicities. The SMTC window duration can be configured from the value set {1, 2, 3, 4, 5} ms (where the unit used in the configuration is subframe, which has a duration of 1 ms).

The WD may use the same RF module for measurements of neighboring cells and data transmission in the serving cell. Measurement gaps allow the WD to suspend the data transmission in the serving cell and perform the measurements of neighboring cells. The measurement gap repetition periodicity can be configured from the value set {20, 40, 80, 160} ms, the gap length can be configured from the value set {1.5, 3, 3.5, 4, 5.5, 6, 10, 20} ms. Usually, the measurement gap length is configured to be larger than the SMTC window duration to allow for RF retuning time. Measurement gap time advance is also introduced to fine tune the relative position of the measurement gap with respect to the SMTC window. The measurement gap timing advance can be configured from the value set {0, 0.25, 0.51 ms.

FIG. 2 provides an example illustration of SSB, SMTC window, and measurement gap.

### Measurement Gaps

Measurement gap pattern (MGP) may be used by the WD for performing measurements on cells of the non-serving carriers (e.g. inter-frequency carrier, inter-RAT carriers etc.). In NR gaps may also be used for measurements on cells of the serving carrier in some scenarios, e.g., if the measured signals (e.g. SSB) are outside the bandwidth part (BWP) of the serving cell. The WD may be scheduled in the serving cell only within the BWP. During the gap the WD cannot be scheduled for receiving/transmitting signals in the serving cell. A measurement gap pattern may be characterized or defined by several parameters: measurement gap length (MGL), measurement gap repetition period (MGRP) and measurement gap time offset with respect to reference time (e.g., slot offset with respect to a serving cell subframe number (SFN) such as SFN=0). An example of MGP is shown in FIG. 2. As a nonlimiting example, MGL can be 1.5, 3, 3.5, 4, 5.5 or 6 ms, and MGRP can be 20, 40, 80 or 160 ms. Such type of MGP is configured by the network node and is also called as network controlled or network configurable MGP. Therefore, the serving base station is aware of the timing of each gap within the MGP.

FIG. 3 illustrates an example of the measurement gap pattern in NR.

In NR there are two major categories of MGPs: per-WD measurement gap patterns and per-FR measurement gap patterns. In NR, the spectrum is divided into two frequency ranges namely FR1 and FR2. FR1 is currently defined from 410 MHz to 7125 MHz. FR2 range is currently defined from 24250 MHz to 52600 MHz. The FR2 range is also interchangeably called as millimeter wave (mmwave), and corresponding bands in FR2 are called as mmwave bands. More frequency ranges may be specified such as FR3. An example of FR3 is frequency ranging above 52600 MHz or between 52600 MHz and 71000 MHz or between 7125 MHz and 24250 MHz.

When configured with per-WD MGP, the WD creates gaps on all the serving cells (e.g. PCell, PSCell, SCells etc.) regardless of their frequency range. The per-WD MGP can be used by the WD for performing measurements on cells of any carrier frequency belonging to any RAT or frequency range (FR). When configured with per-FR MGP (if WD supports this capability), the WD may create gaps only on the serving cells of the indicated FR for which carriers are to be measured. For example, if the WD is configured with per-FR1 MGP, then the WD creates measurement gaps only on serving cells (e.g. PCell, PSCell, SCells etc.) of FR1 while no gaps are created on serving cells on carriers of FR2. The per-FR1 gaps can be used for measurement on cells of only FR1 carriers. Similarly, per-FR2 gaps when configured are only created on FR2 serving cells and can be used for measurement on cells of only FR2 carriers. Support for per FR gaps is a WD capability, i.e. certain WD may only support per WD gaps according to their capability.

An example RRC message for measurement gap configuration provided by network node to WD is shown below.

### -MeasGapConfig

The IE MeasGapConfig specifies the measurement gap configuration and controls setup/release of measurement gaps.

### MeasGapConfig Information Element

-- ASNISTART
-- TAG-MEASGAPCONFIG-START

| MeasGapConfig ::= | SEQUENCE { | |
|---|---|---|
| gapFR2 | SetupRelease { GapConfig } | OPTIONAL, -- |

```
Need M
  ...,
  [[
```

| | | |
|---|---|---|
| gapFR1 | SetupRelease { GapConfig } | OPTIONAL, -- |

Need M

| | | |
|---|---|---|
| gapUE | SetupRelease { GapConfig } | OPTIONAL -- |

Need M
]]
}

| | |
|---|---|
| GapConfig ::= | SEQUENCE { |
| gapOffset | INTEGER (0..159), |
| mgl | ENUMERATED {ms1dot5, ms3, ms3dot5, ms4, ms5dot5, |

ms6},

| | |
|---|---|
| mgrp | ENUMERATED {ms20, ms40, ms80, ms160}, |
| mgta | ENUMERATED {ms0, ms0dot25, ms0dot5}, |

```
  ...,
  [[
```

| | |
|---|---|
| refServCellIndicator | ENUMERATED {pCell, pSCell, mcg-FR2} |

```
OPTIONAL -- Cond NEDCorNRDC
  ]],
  [[
```

| | | |
|---|---|---|
| refFR2ServCellAsyncCA-r16 | ServCellIndex | OPTIONAL, -- |

Cond AsyncCA

| | | |
|---|---|---|
| mgl-r16 | ENUMERATED {ms10, ms20} | OPTIONAL -- |

Cond PRS
]]
}
-- TAG-MEASGAPCONFIG-STOP
-- ASN1STOP

Field descriptions corresponding to the example RRC message for measurement gap configuration are included below in Table 2.

TABLE 2
MeasGapConfig field descriptions. MeasGapConfig field descriptions

| gapFR1 | |
|---|---|
| Indicates measurement gap configuration that applies to FR1 only. In (NG)EN- | |
| DC, gapFR1 cannot be set up by NR RRC (i.e., only LTE RRC can configure | |
| FR1 measurement gap). In NE-DC, gapFR1 can only be set up by NR RRC (i.e., | |
| LTE RRC cannot configure FR1 gap). In NR-DC, gapFR1 can only be set up in | |
| the measConfig associated with MCG. gapFR1 cannot be configured together | |
| with gapUE. The applicability of the FR1 measurement gap is according to | |
| Table 9.1.2-2 and Table 9.1.2-3 in TS 38.133 [14]. | |
| gapFR2 | |
| Indicates measurement gap configuration applies to FR2 only. In (NG)EN-DC | |
| or NE-DC, gapFR2 can only be set up by NR RRC (i.e., LTE RRC cannot | |
| configure FR2 gap). In NR-DC, gapFR2 can only be set up in the measConfig | |
| associated with MCG. gapFR2 cannot be configured together with gapUE. The | |
| applicability of the FR2 measurement gap is according to Table 9.1.2-2 and | |
| Table 9.1.2-3 in TS 38.133 [14]. | |
| gapUE | |
| Indicates measurement gap configuration that applies to all frequencies (FR1 | |
| and FR2). In (NG)EN-DC, gapUE cannot be set up by NR RRC (i.e., only LTE | |
| RRC can configure per WD measurement gap). In NE-DC, gapUE can only be | |
| set up by NR RRC (i.e., LTE RRC cannot configure per WD gap). In NR-DC, | |
| gapUE can only be set up in the measConfig associated with MCG. If gapUE is | |
| configured, then neither gapFR1 nor gapFR2 can be configured. The | |
| applicability of the per WD measurement gap is according to Table 9.1.2-2 and | |
| Table 9.1.2-3 in TS 38.133 [14]. | |
| gapOffset | |
| Value gapOffset is the gap offset of the gap pattern with MGRP indicated in the | |
| field mgrp. The value range is from 0 to mgrp-1. | |
| mgl | |
| Value mgl is the measurement gap length in ms of the measurement gap. The | |
| measurement gap length is according to in Table 9.1.2-1 in TS 38.133 [14]. | |
| Value ms1dot5 corresponds to 1.5 ms, ms3 corresponds to 3 ms and so on. If | |
| mgl-r16 is present, WD shall ignore the mgl (without suffix). | |
| mgrp | |
| Value mgrp is measurement gap repetition period in (ms) of the measurement | |
| gap. The measurement gap repetition period is according to Table 9.1.2-1 in TS | |
| 38.133 [14]. | |
| mgta | |
| Value mgta is the measurement gap timing advance in ms. The applicability of | |
| the measurement gap timing advance is according to clause 9.1.2 of TS 38.133 | |
| [14]. Value ms0 corresponds to 0 ms, ms0dot25 corresponds to 0.25 ms and | |
| ms0dot5 corresponds to 0.5 ms. For FR2, the network only configures 0 ms and | |
| 0.25 ms. | |
| refFR2ServCellIAsyncCA | |
| Indicates the FR2 serving cell identifier whose SFN and subframe is used for | |
| FR2 gap calculation for this gap pattern with asynchronous CA involving FR2 | |
| carrier(s). | |
| refServCellIndicator | |
| Indicates the serving cell whose SFN and subframe are used for gap calculation | |
| for this gap pattern. Value pCell corresponds to the PCell, pSCell corresponds to | |
| the PSCell, and mcg-FR2 corresponds to a serving cell on FR2 frequency in | |
| MCG. | |
| Conditional | |
| Presence | Explanation |
| AsyncCA | This field is mandatory present when configuring FR2 gap |
| | pattern to WD in: |
| | (NG)EN-DC or NR SA with asynchronous CA |
| | involving FR2 carrier(s); |
| | NE-DC or NR-DC with asynchronous CA involving |
| | FR2 carrier(s), if the field refServCellIndicator is set |
| | to mcg-FR2. |
| | In case the gap pattern to WD in NE-DC and NR-DC is |
| | already configured and the serving cell used for the gap |
| | calculation corresponds to a serving cell on FR2 frequency |
| | in MCG, then the field is optionally present, need M. |
| | Otherwise, it is absent, Need R. |
| NEDCorNRDC | This field is mandatory present when configuring gap |
| | pattern to WD in NE-DC or NR-DC. In case the gap pattern |
| | to WD in NE-DC and NR-DC is already configured, then |
| | the field is absent, need M. Otherwise, it is absent. |
| PRS | This field is optionally present, Need R, when configuring |
| | gap pattern to WD for measurements of DL-PRS configured |
| | via LPP (TS 37.355 [49]). Otherwise, it is absent. |

### SUMMARY

Some embodiments advantageously provide methods, systems, and apparatuses for measurements scaling for measurement gap in NTN. In one or more embodiments a scaling factor for at least one measurement gap (MG) in at least one measurement gap pattern (MGP) is determined, and/or one or more measurements associated with the at least one MG is/are performed on received signaling based on the determined scaling factor. One or more embodiments of the present disclosure are beneficial at least because measurements associated with one or more MGs of signaling in an NTN can be performed taking into account at least one of network information such as conditions of the network (e.g., non-terrestrial network), satellite information, type of satellite (e.g., moving satellite), satellite beams such as steerable or fixed beams, location of satellite (e.g., with respect to a wireless device), propagation delays, etc. That is, measurements can be adjusted, adapted, and/or determined (e.g., in a timely manner) to conform to the characteristics of the NTN, e.g., so that measurements are not missed and/or unnecessarily repeated, thereby reducing power consumption at least on the wireless device and/or overhead of signaling associated with the NTN.

In one embodiment, a network node is configured to obtain an indication of a scaling factor for a measurement gap; and receive information about a measurement, the measurement being based on the scaling factor.

In one embodiment, a wireless device (WD) is configured to obtain an indication of a scaling factor for a measurement gap (MG); and perform a measurement based on the scaling factor.

According to one aspect, a method in a wireless device (WD) configured to communicate with a network node is described. The method comprises determining a scaling factor for at least one measurement gap (MG) in at least one measurement gap pattern (MGP), where the scaling factor is based on at least one of network information and a WD capability; performing a measurement associated with the at least one MG on received signaling (e.g., transmitted by a network node) based on the determined scaling factor, where the received signaling includes the at least one MG in the at least one MGP; and transmitting information about the measurement.

In some embodiments, the at least one MGP meets at least one signal reception proximity (SRP) condition of at least one of a first plurality of SRP conditions, a second plurality of SRP conditions, and a third plurality of SRP conditions.

In some other embodiments, the first plurality of SRP conditions includes: a first difference (T11−T21) between a first starting point (T11) and a second starting point (T21) in time of corresponding gaps (e.g., measurement gaps, measurement gap occasions, etc.) of the at least one MGP is within a first time duration (A; a second difference (T11−T22) between the first starting point (T11) of a first gap in a first MGP of the at least one MGP and a first ending point (T22) in time of a second gap in a second MGP of the at least one MGP is within a second time duration (a; and a third difference (T12−T21) between a second ending point (T12) in time of the first gap in the first MGP and the second starting point in time (T21) of the second gap in the second MGP is within a third time duration (β). At least one of the first, second, and third differences is a time difference.

In an embodiment, the second plurality of SRP conditions includes the first difference (T11−T21) is greater than a fourth time duration (Δ1) but less than a fifth time duration (Δ2); the second difference (T11−T22) is greater than a sixth time duration (α1) but smaller than a seventh time duration (α2); and the third difference (T12−T21) is greater than an eight time duration (β1) but less than a ninth time duration (02).

In another embodiment, the third plurality of SRP conditions includes: the first difference (T11−T21) is greater than a tenth time duration (Δa); the second difference (T11−T22) is greater than an eleventh time duration (αa); and the third difference (T12−T21) is greater than a twelfth time duration (βa).

In some embodiments at least one of the scaling factor triggers one of an equal measurement opportunity and an unequal measurement opportunity for the measurement to be performed among one or more MGs having different priority; and the scaling factor indicates a proportion of MGs between at least two MGs of the at least one MG. The proportion of MGs may refer to one or more percentage each MG occupies, how much an MG1 is measured, and how much another MG2 is measured such as based on a ratio between MG1 and MG2. The proportion may be predetermined using a predefined rule.

In some other embodiments, one of the radio interface is configured to receive an indication of the scaling factor from the network node; and the scaling factor is pre-configured in the WD.

In an embodiment, at least one of the indication of the scaling factor indicates at least one of activated and deactivated MGs of the at least one MG; and the at least one of activated and deactivated MGs meets at least one SRP condition (e.g., if two MGs meet SRP, then one MG may be deactivated.

In another embodiment, at least one of the network node is a non-terrestrial network node (NTN); the at least one MG is received by the WD at a reception time based on a propagation delay associated with the NTN; and the scaling factor triggers the WD to at least one of perform the measurement associated with the at least one MG at a measurement time corresponding to the reception time and transmit information about the measurement, where the information about the measurement is usable by the network node to update the scaling factor.

According to another aspect, a wireless device (WD) configured to communicate with a network node is described. The WD comprises a radio interface and processing circuitry in communication with the radio interface. The processing circuitry is configured to determine a scaling factor for at least one measurement gap (MG) in at least one measurement gap pattern (MGP), where the scaling factor is based on at least one of network information and a WD capability; perform a measurement associated with the at least one MG on received signaling based on the determined scaling factor, where the received signaling includes the at least one MG in the at least one MGP; and the radio interface is configured to transmit information about the measurement.

In some embodiments, the at least one MGP meets at least one signal reception proximity (SRP) condition of at least one of a first plurality of SRP conditions, a second plurality of SRP conditions, and a third plurality of SRP conditions.

In some other embodiments, the first plurality of SRP conditions includes a first difference (T11−T21) between a first starting point (T11) and a second starting point (T21) in time of corresponding gaps of the at least one MGP is within a first time duration (Δ); a second difference (T11−T22) between the first starting point (T11) of a first gap in a first MGP of the at least one MGP and a first ending point (T22) in time of a second gap in a second MGP of the at least one MGP is within a second time duration (α; and a third difference (T12−T21) between a second ending point (T12) in time of the first gap in the first MGP and the second starting point in time (T21) of the second gap in the second MGP is within a third time duration (β).

In an embodiment, the second plurality of SRP conditions includes the first difference (T11−T21) is greater than a fourth time duration (Δ1) but less than a fifth time duration (Δ2); the second difference (T11−T22) is greater than a sixth time duration (α1) but smaller than a seventh time duration (α2); and the third difference (T12−T21) is greater than an eight time duration (β1) but less than a ninth time duration (β2).

In another embodiment, the third plurality of SRP conditions includes the first difference (T11−T21) is greater than a tenth time duration (Δa); the second difference (T11−T22) is greater than an eleventh time duration (αa); and the third difference (T12−T21) is greater than a twelfth time duration (βa).

In some embodiments, at least one of the scaling factor triggers one of an equal measurement opportunity and an unequal measurement opportunity for the measurement to be performed among one or more MGs having different priority; and the scaling factor indicates a proportion of MGs between at least two MGs of the at least one MG.

In some other embodiments, one of the radio interface is configured to receive an indication of the scaling factor from the network node; and the scaling factor is pre-configured in the WD.

In an embodiment, at least one of the indication of the scaling factor indicates at least one of activated and deactivated MGs of the at least one MG; and the at least one of activated and deactivated MGs meets at least one SRP condition.

In another embodiment, at least one of the network node is a non-terrestrial network node (NTN); the at least one MG is received by the WD at a reception time based on a propagation delay associated with the NTN; and the scaling factor triggers the WD to at least one of perform the measurement associated with the at least one MG at a measurement time corresponding to the reception time and transmit information about the measurement, the information about the measurement being usable by the network node to update the scaling factor.

According to one aspect, a method in a network node configured to communicate with a wireless device (WD) is described. The method comprises determining a scaling factor for at least one measurement gap (MG) in at least one measurement gap pattern (MGP), where the scaling factor is based on at least one of network information and a WD capability; and receiving information about the measurement from the WD, the measurement is based on the scaling factor and is associated with the at least one MG.

In some embodiments, the at least one MGP meets at least one signal reception proximity (SRP) condition of at least one of a first plurality of SRP conditions, a second plurality of SRP conditions, and a third plurality of SRP conditions.

In some other embodiments, the first plurality of SRP conditions includes a first difference (T11−T21) between a first starting point (T11) and a second starting point (T21) in time of corresponding gaps of the at least one MGP is within a first time duration (Δ); a second difference (T11−T22) between the first starting point (T11) of a first gap in a first MGP of the at least one MGP and a first ending point (T22) in time of a second gap in a second MGP of the at least one MGP is within a second time duration (α); and a third difference (T12−T21) between a second ending point (T12) in time of the first gap in the first MGP and the second starting point in time (T21) of the second gap in the second MGP is within a third time duration (β).

In an embodiment, the second plurality of SRP conditions includes the first difference (T11−T21) is greater than a fourth time duration (Δ1) but less than a fifth time duration (Δ2); the second difference (T11−T22) is greater than a sixth time duration (α1) but smaller than a seventh time duration (α2); and the third difference (T12−T21) is greater than an eight time duration (β1) but less than a ninth time duration (02).

In another embodiment, the third plurality of SRP conditions includes the first difference (T11−T21) is greater than a tenth time duration (Δa); the second difference (T11−T22) is greater than an eleventh time duration (αa); and the third difference (T12−T21) is greater than a twelfth time duration (βa).

In some embodiments, at least one of the scaling factor triggers one of an equal measurement opportunity and an unequal measurement opportunity for the measurement to be performed among one or more MGs having different priority; and the scaling factor indicates a proportion of MGs between at least two MGs of the at least one MG.

In some other embodiments, one of the method further includes transmitting an indication of the scaling factor to the WD; and the scaling factor is pre-configured in the WD.

In an embodiment, at least one of the indication of the scaling factor indicates at least one of activated and deactivated MGs of the at least one MG; and the at least one of activated and deactivated MGs meets at least one SRP condition.

In another embodiment, at least one of the network node is a non-terrestrial network node (NTN); the at least one MG is received by the WD at a reception time based on a propagation delay associated with the NTN; and the scaling factor triggers the WD to at least one of perform the measurement associated with the at least one MG at a measurement time corresponding to the reception time and transmit information about the measurement; and the method further includes updating the scaling factor based on the information about the measurement.

According to another aspect, a network node configured to communicate with a wireless device (WD) is described. The network node comprises a radio interface and processing circuitry in communication with the radio interface. The processing circuitry is configured to determine a scaling factor for at least one measurement gap (MG) in at least one measurement gap pattern (MGP) the scaling factor being based on at least one of network information a and a WD capability. The radio interface is configured to receive information about the measurement from the WD, where the measurement is based on the scaling factor and is associated with the at least one MG.

In some embodiments, the at least one MGP meets at least one signal reception proximity (SRP) condition of at least one of a first plurality of SRP conditions, a second plurality of SRP conditions, and a third plurality of SRP conditions.

In some other embodiments, the first plurality of SRP conditions includes a first difference (T11−T21) between a first starting point (T11) and a second starting point (T21) in time of corresponding gaps of the at least one MGP is within a first time duration (Δ); a second difference (T11−T22) between the first starting point (T11) of a first gap in a first MGP of the at least one MGP and a first ending point (T22) in time of a second gap in a second MGP of the at least one MGP is within a second time duration (α); and a third difference (T12−T21) between a second ending point (T12) in time of the first gap in the first MGP and the second starting point in time (T21) of the second gap in the second MGP is within a third time duration (β).

In an embodiment, the second plurality of SRP conditions includes the first difference (T11−T21) is greater than a fourth time duration (Δ1) but less than a fifth time duration (Δ2); the second difference (T11−T22) is greater than a sixth time duration (α1) but smaller than a seventh time duration (α2); and the third difference (T12−T21) is greater than an eight time duration (β1) but less than a ninth time duration (02).

In another embodiment, the third plurality of SRP conditions includes the first difference (T11−T21) is greater than a tenth time duration (Δa); the second difference (T11−T22) is greater than an eleventh time duration (αa); and the third difference (T12−T21) is greater than a twelfth time duration (βa).

In some embodiments, at least one of the scaling factor triggers one of an equal measurement opportunity and an unequal measurement opportunity for the measurement to be performed among one or more MGs having different priority; and the scaling factor indicates a proportion of MGs between at least two MGs of the at least one MG.

In some other embodiments, one of the radio interface is configured to transmit an indication of the scaling factor to the WD; and the scaling factor is pre-configured in the WD.

In an embodiment, at least one of the indication of the scaling factor indicates at least one of activated and deactivated MGs of the at least one MG; and the at least one of activated and deactivated MGs meets at least one SRP condition.

In another embodiment, at least one of the network node is a non-terrestrial network node (NTN); the at least one MG is received by the WD at a reception time based on a propagation delay associated with the NTN; the scaling factor triggers the WD to at least one of perform the measurement associated with the at least one MG at a measurement time corresponding to the reception time and transmit information about the measurement; and the processing circuitry is further configured to update the scaling factor based on the information about the measurement.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates an example architecture of a satellite network with bent pipe transponders (gNB may be integrated in the gateway or connected to the gateway via a terrestrial connection (wire, optic fiber, wireless link));

FIG. 2 illustrates an example of SSB, SMTC, and measurement gap;

FIG. 3 illustrates an example of the measurement gap pattern in NR;

FIG. 4 illustrates an example of distance difference between two satellites;

FIG. 5 is a schematic diagram of an example network architecture illustrating a communication system connected via an intermediate network to a host computer according to the principles in the present disclosure;

FIG. 6 is a block diagram of a host computer communicating via a network node with a wireless device over an at least partially wireless connection according to some embodiments of the present disclosure;

FIG. 7 is a flowchart illustrating example methods implemented in a communication system including a host computer, a network node and a wireless device for executing a client application at a wireless device according to some embodiments of the present disclosure;

FIG. 8 is a flowchart illustrating example methods implemented in a communication system including a host computer, a network node and a wireless device for receiving user data at a wireless device according to some embodiments of the present disclosure;

FIG. 9 is a flowchart illustrating example methods implemented in a communication system including a host computer, a network node and a wireless device for receiving user data from the wireless device at a host computer according to some embodiments of the present disclosure;

FIG. 10 is a flowchart illustrating example methods implemented in a communication system including a host computer, a network node and a wireless device for receiving user data at a host computer according to some embodiments of the present disclosure;

FIG. 11 is a flowchart of an example process in a wireless device according to some embodiments of the present disclosure;

FIG. 12 is a flowchart of an example process in a network node according to some embodiments of the present disclosure;

FIG. 13 is a flowchart of another example process in a wireless device according to some embodiments of the present disclosure;

FIG. 14 is a flowchart of another example process in a network node according to some embodiments of the present disclosure;

FIG. 15 illustrates an example of a multi-SMTC scenario according to some embodiments of the present disclosure;

FIG. 16 illustrates an example of 4 MGs according to some embodiments of the present disclosure;

FIG. 17 illustrates an example of MG sets for 4 MGs according to some embodiments of the present disclosure;

FIG. 18 illustrates an example of MG set and cascading Kscaling according to some embodiments of the present disclosure;

FIG. 19 illustrates an example of some instances of MG set and cascading Kscaling according to some embodiments of the present disclosure;

FIG. 20 illustrates another example of some instances of MG set and cascading Kscaling according to some embodiments of the present disclosure;

FIG. 21 illustrates an example of some instances of MG set and cascading Kscaling according to some embodiments of the present disclosure; and

FIG. 22 illustrates an example of MG set and cascading Kscaling with meets SRP1 or SRP2 according to some embodiments of the present disclosure.

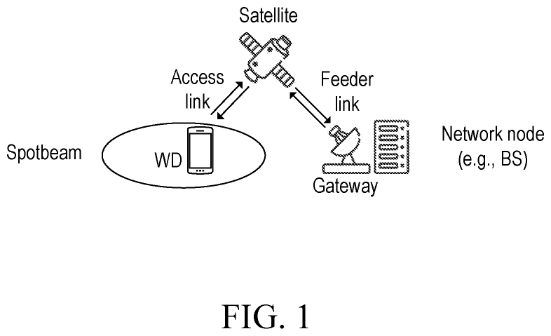

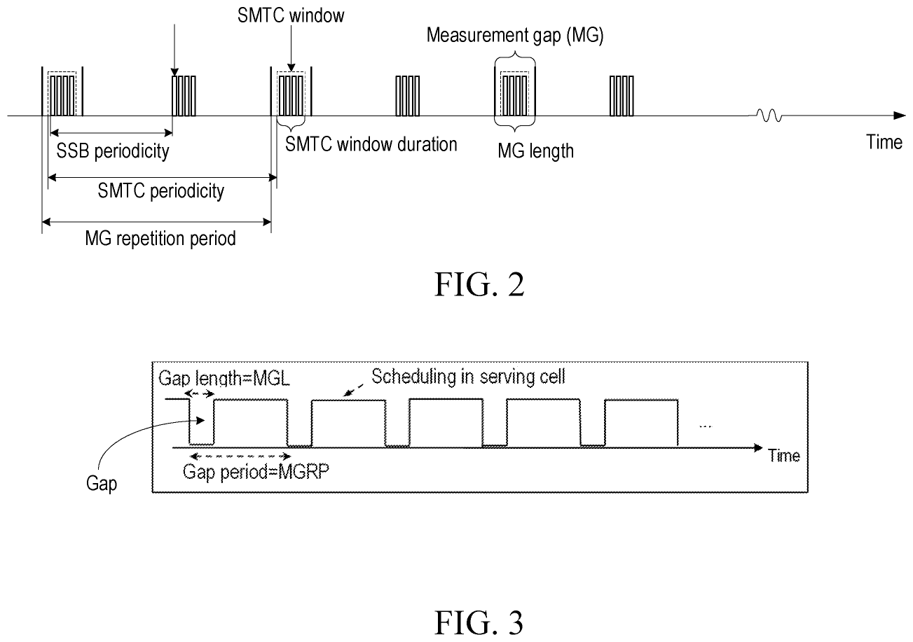

### DETAILED DESCRIPTION

Satellites such as moving satellites communicate using features that result in moving cells and/or switching cells and/or propagation delays and/or interrupted communication with wireless devices. More specifically, existing wireless technologies such as wireless communication in NTN do not adequately provide a process to adapt measurements (e.g., MG measurements) based on the characteristics of the NTN.

The following can be considered as main challenges that need to be addressed in NTN: moving satellites (resulting in moving cells or switching cells), long propagation delays. More specifically:
Moving satellites (resulting in moving or switching cells): The default assumption in terrestrial network design, e.g. NR or LTE, is that cells are stationary. This is not the case in NTN, especially when LEO satellites are considered. A LEO satellite may be visible to (i.e., detectable by, in communication with) a WD on the ground only for a few seconds or minutes. There may be two different options for LEO deployment. The beam/cell coverage is fixed with respect to a geographical location with earth-fixed beams, i.e. steerable beams from satellites ensure that a certain beam covers the same geographical area even as the satellite moves in relation to the surface of the earth. On the other hand, with moving beams a LEO satellite has fixed antenna pointing direction in relation to the earth's surface, e.g. perpendicular to the earth's surface, and thus cell/beam coverage sweeps the earth as the satellite moves. In that case, the spotbeam, which is serving the WD, may switch every few seconds.
Long propagation delays: The propagation delays in terrestrial mobile systems are usually less than 1 millisecond. However, the propagation delays in NTN can be much longer, ranging from several milliseconds (e.g., for LEO) to hundreds of milliseconds (e.g., for GEO) depending on the altitudes of the spaceborne or airborne platforms deployed in the NTN.

SMTC, measurement gap (MG) and the different variants thereof are efficient means to facilitate (for a WD) finding relevant SSB transmissions and limiting the SSB search and measurement effort in terrestrial networks. However, the special properties of NTNs impose problems that are not present in terrestrial networks, for which the traditional SMTC definition is not adapted.

Compared to terrestrial networks, the distances between sender and transmitter may be very long in NTNs and may vary depending on the satellite position/location in relation to the WD. In addition, cells in an NTN are typically very large, which means that the difference in satellite-WD propagation delay may differ significantly between two different locations in the same cell, e.g. compared to the SMTC offset and duration parameters. Even though the SSB/CSI-RS transmissions from different satellites are synchronized and transmitted at the same time, they will still arrive at the WD at different times because of the differences in distance and thus propagation delay.

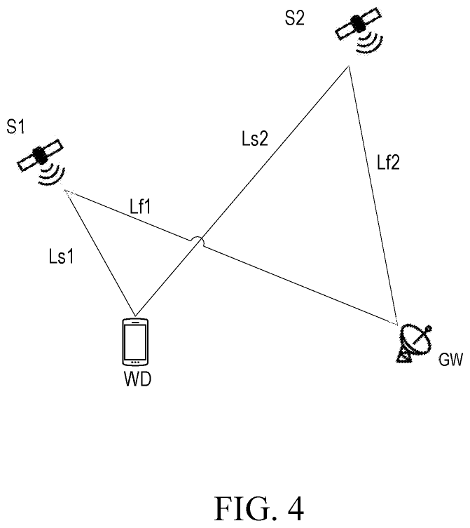

The WD may miss the SSB/CSI-RS (Channel State Information Reference Signal) measurement window of adjacent satellites in the NTN system, as shown in FIG. 4 (which illustrates an example of distance difference between two satellites). As a result, the propagation delay or propagation delay difference information may be considered in determining the measurement configuration comprising both SMTC and MG.

3GPP radio access network 2 (RAN2) has agreed that the multiple SMTC configurations are enabled by introducing different new offsets in addition to the legacy SMTC configuration. 3GPP has also agreed to assign for further study (FFS) the determination of how the offsets will be managed/signaled.

Hence, for network/NW-based SMTC/GAP (i.e., gap) Configuration scheme, the final SMTC/measurement gap configuration may be generated and provided by NW, based on the propagation delay difference between at least one target cell and the serving cell of a given WD. The network (e.g., the network node) can derive the propagation delay difference between at least one target cell and the serving cell according to the ephemeris and/or WD reported information such as propagation delay or WD location, etc., which is similar to the traditional procedure of WD transmitting a request to the NW, and the serving cell correspondingly provided proper measurement configuration to the WD taking the WD reported information into account.

Some embodiments propose a mechanism for the WD in NTN (e.g. WD served by NTN node) to perform measurements with a scaling factor of a MG (Measurement gap). The term scaling factor of a MG may also be called as sharing, priority, factor, etc. The WD may be configured such that the WD measurements follow defined measurement requirements (e.g., measurement rate, periodicity, time, length etc.) and the measurement configurations (e.g., number of MG in multi-SMTC/MG configuration) based on condition of one or more of three sets of cases:

Case 1: The configured measurement gap patterns (MGPs) which meets at least a first signal reception proximity (SRP1) condition.

Examples of one or more criteria for the MGPs to meet the SRP1 conditions are:
SRP1 is met for the MGPs if the magnitude of the difference (T11−T21) between the starting points in time(T11 and T21) of the individual gaps is within the time duration(Δ).
SRP1 is met for the MGPs if the magnitude of the difference (T11−T22) between the starting point in time (T11) of the gap in a first MGP and the ending point in time (T22) of the gap in a second MGP is within the time duration(α).
SRP1 is met for the MGPs if the magnitude of the difference (T12−T21) between the ending point in time (T12) of the gap in a first MGP and the starting point in time (T21) of the gap in a second MGP is within the time duration(β).

Case 2: The configured measurement gap patterns (MGPs) which meets at least a second signal reception proximity2 (SRP2) condition.

Examples of one or more criteria for the MGPs to meet the SRP2 conditions are:
SRP2 is met for the MGPs if the magnitude of the difference (T11−T21) between the starting points in time(T11 and T21) of the individual gaps is larger than a time duration(Δ1), but smaller than a time duration(Δ2).
SRP2 is met for the MGPs if the magnitude of the difference (T11−T22) between the starting point in time (T11) of the gap in a first MGP and the ending point in time (T22) of the gap in a second MGP is larger than a time duration(α1), but smaller than a time duration(α2).
SRP2 is met for the MGPs if the magnitude of the difference (T12−T21) between the ending point in time (T12) of the gap in a first MGP and the starting point in time (T21) of the gap in a second MGP is larger than a time duration(31), but smaller than a time duration(β2).

Case 3: The configured measurement gap patterns (MGPs) which meets at least a third signal reception proximity3 (SRP3) condition.

Examples of one or more criteria for the MGPs to meet the SRP3 conditions are:
SRP3 is met for the MGPs if the magnitude of the difference (T11−T21) between the starting points in time(T11 and T21) of the individual gaps is larger than the time duration (Δa).
SRP3 is met for the MGPs if the magnitude of the difference (T11−T22) between the starting point in time (T11) of the gap in a first MGP and the ending point in time (T22) of the gap in a second MGP is larger than the time duration(αa).
SRP3 is met for the MGPs if the magnitude of the difference (T12−T21) between the ending point in time (T12) of the gap in a first MGP and the starting point in time (T21) of the gap in a second MGP is larger than the time duration(βa).

According to a first embodiment, a scaling sharing solution for MG provide sharing between consecutive MGs (e.g., a scaling factor usable for performing measurements associated with one or more MGs). Examples of a solution to determine the scaling factor to be used in the WD (e.g. in different scenarios) are described below:

1. In one example, a scaling factor can be provided to the WD with equal or unequal measurement opportunity among MG, e.g., including setting of different priority of MGs, or different priority of satellites.
a. Equal measurement opportunity may refer to the WD(and/or NN) measuring/determining an amount/percentage (e.g., identical amount/percentage) of one or more MG occasions of any MG among a plurality of MGs (e.g., all MGs) during measurements with MGs.
b. Unequal measurement opportunity may refer to the WD (and/or NN) measuring/determining a pre-defined amount/percentage of MG occasion of any MG among a plurality of MGs (e.g., all MGs) during measurements with MGs, e.g., where amount/percentage may be different for different MGs.

2. In another example, a scaling factor can be provided to WD with a proportion of MGs, such as a MG1 occupies percentage A %, MG2 occupies percentage B %, MG3 occupies percentage C % and MG4 occupies percentage D %. The scaling factor for MG1 can be K_{MG1}=ceiling(1/A*100) and for MG2 can be K_{MG2}=ceiling(1/B*100) and for MG3 can be K_{MG3}=ceiling(1/C*100) and for MG4 can be K_{MG4}=ceiling(1/D*100).

According to a second embodiment, a scaling indication solution for MGs provides an indication (e.g., MG indication) of consecutive MGs, which implies an implicit sharing percentage among consecutive MGs. Examples of a solution to determine the scaling indication for MGs to be used in the WD are described below:
1. Network (e.g., network node) can send the indication (e.g., MG indication, scaling indication, signaling indication) to WD which indicates the activated or deactivated MG(s). Accordingly, the network node and the WD can synchronize a scaling rule (e.g., synchronously). Here, activated MGs may be referred to as enabled, prioritized MGs, etc. Deactivated MGs may be referred to as disabled, deprioritized, dropped MGs, etc.
2. There can be a pre-defined rule for the WD (e.g., transmitted by the network to the WD, pre-configured in the WD, etc.) which indicates the activated and/or deactivated MG(s) once the MGs meet SRP conditions. For example, if a difference between (i.e., a difference between at least two parameters corresponding to) the MGs (e.g., the first MG, MG1 and the second MG, MG2) meets SRP1, MG1 and/or MG2 may be activated.

According to a third embodiment, scaling solution (e.g., scaling sharing solution, and scaling indication solution, scaling factor, etc.) can be adaptively changed/updated by the network node, implicitly or explicitly, with conditions (e.g., RSRP, time, location, or network KPI) which fulfill predefined criteria or threshold.

According to a fourth embodiment, scaling solution (e.g., scaling sharing solution, and scaling indication solution, scaling factor, etc.) can be adaptively changed/updated once network receives signaling of WD capacity/capability of handling different configurations of MGs, i.e. case1, case2 and case 3 in above.

According to a fifth embodiment, configurations of MGs can be adaptively changed/updated by network once network receives signaling of WD's capacity or choice of handling different scaling solution.

One or more embodiments of the present disclosure provide mechanisms for the WD to adjust measurements in a timely manner and/or provide a way for the WD to efficiently perform measurements such as for mobility and signaling in NTN, thereby reducing power consumption of WD and overhead of signaling.

Before describing in detail example embodiments, it is noted that the embodiments reside primarily in combinations of apparatus components and processing steps related to measurements scaling for measurement gap in NTN. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3^{rd} party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Network information may refer to any information associated with the network such as conditions of the network (e.g., non-terrestrial network), satellite information, type of satellite, satellite beams such as steerable or fixed beams, location of satellite (e.g., with respect to a wireless device), propagation delays, etc.

### Additional Terminology

In this disclosure, the term “satellite” is often used even when a more appropriate term would be “gNB or network node associated with the satellite”. The term “satellite” may also be called as a satellite node, an NTN node, node in the space etc. Here, gNB associated with a satellite might include both a regenerative satellite, where the gNB is the satellite payload, i.e. the gNB is integrated with the satellite, or a transparent satellite, where the satellite payload is a relay and gNB is on the ground (i.e. the satellite relays the communication between the gNB on the ground and the WD). In addition, the specific term gNB may be used herein interchangeably with the more general term network node (NN).

Time period or duration over which a WD can maintain connection, or can camp on, or can maintain communication, and so on to a satellite or a gNB by WD is referred to as term “coverage time” or “serving time” or “network availability” or “sojourn time” or “dwell time” etc. Term ‘Non-coverage time’, also known as “non-serving time” or “network unavailability”, or “non-sojourn time” or “non-dwell time” refers to a period of time during which a satellite or gNB cannot serve or communicate or provide coverage to a WD. Another way to interpret the availability is that is not about a satellite/network strictly not able to serve the WD due to lack of coverage, but that WD does not need to measure certain “not likely to be serving cell(satellite via which serving cell is broadcasted)”. In this case, the terminology may still be as in no coverage case or it may be different, e.g. “no need to measure”.

The term node is used which can be a network node or a user equipment (UE). Examples of network nodes are NodeB, base station (BS), multi-standard radio (MSR) radio node such as MSR BS, eNodeB, gNodeB, MeNB, SeNB, location measurement unit (LMU), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, transmission reception point (TRP), remote radio unit (RRU), remote radio head (RRH), nodes in distributed antenna system (DAS), core network node (e.g. MSC, MME etc.), O&M, OSS, SON, positioning node (e.g. E-SMLC), etc.

The non-limiting term WD refers to any type of wireless device communicating with a network node and/or with another WD in a cellular or mobile communication system. Examples of WD are target device, device to device (D2D) WD, vehicular to vehicular (V2V), machine type WD, MTC WD or WD capable of machine to machine (M2M) communication, PDA, tablet, mobile terminals, smart phone, laptop embedded equipment (LEE), laptop mounted equipment (LME), USB dongles etc.

The term radio access technology, or RAT, may refer to any RAT e.g. UTRA, E-UTRA, narrow band internet of things (NB-IoT), WiFi, Bluetooth, next generation RAT, New Radio (NR), 4G, 5G, etc. Any of the equipment denoted by the term node, network node or radio network node may be capable of supporting a single or multiple RATs.

The term signal or radio signal used herein can be any physical signal or physical channel. Examples of DL physical signals are reference signal (RS) such as primary synchronization signal (PSS), secondary synchronization signal (SSS), channel state information reference signal (CSI-RS), demodulation reference signal (DMRS) signals in SS/PBCH block (SSB), discovery reference signal (DRS), cell-specific reference signal (CRS), positioning reference signal (PRS), etc. RS may be periodic e.g. RS occasion carrying one or more RSs may occur with certain periodicity e.g. 20 ms, 40 ms etc. The RS may also be aperiodic. Each SSB carries NR-PSS, NR-SSS and NR-PBCH in 4 successive symbols. One or multiple SSBs are transmit in one SSB burst which is repeated with certain periodicity e.g. 5 ms, 10 ms, 20 ms, 40 ms, 80 ms and 160 ms. The WD is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset with respect to reference time (e.g. serving cell SFN) etc. Therefore, SMTC occasion may also occur with certain periodicity e.g. 5 ms, 10 ms, 20 ms, 40 ms, 80 ms and 160 ms. Examples of UL physical signals are reference signal such as SRS, DMRS etc. The term physical channel refers to any channel carrying higher layer information e.g. data, control etc. Examples of physical channels are PBCH, NPBCH, PDCCH, PDSCH, sPUCCH, sPDSCH, sPUCCH, sPUSCH, MPDCCH, NPDCCH, NPDSCH, E-PDCCH, PUSCH, PUCCH, NPUSCH etc.

The term “signaling” used herein may comprise any of: high-layer signaling (e.g., via Radio Resource Control (RRC) or a like), lower-layer signaling (e.g., via a physical control channel or a broadcast channel), or a combination thereof. The signaling may be implicit or explicit. The signaling may further be unicast, multicast or broadcast. The signaling may also be directly to another node or via a third node.

The term “radio measurement” used herein may refer to any measurement performed on radio signals. Radio measurements can be absolute or relative. Radio measurement may be called as signal level which may be signal quality and/or signal strength. Radio measurements can be e.g. intra-frequency, inter-frequency, inter-RAT measurements, CA measurements, etc. Radio measurements can be unidirectional (e.g., DL or UL) or bidirectional (e.g., Round Trip Time (RTT), Receive-Transmit (Rx-Tx), etc.). Some examples of radio measurements: timing measurements (e.g., Time of Arrival (TOA), timing advance, RTT, Reference Signal Time Difference (RSTD), Rx-Tx, propagation delay, etc.), angle measurements (e.g., angle of arrival), power-based measurements (e.g., received signal power, Reference Signals Received Power (RSRP), received signal quality, Reference Signals Received Quality (RSRQ), Signal-to-interference-plus-noise Ratio (SINR), Signal Noise Ratio (SNR), interference power, total interference plus noise, Received Signal Strength Indicator (RSSI), noise power, etc.), cell detection or cell identification, radio link monitoring (RLM), system information (SI) reading, etc. The inter-frequency and inter-RAT measurements are carried out by the WD in measurement gaps unless the WD is capable of doing such measurement without gaps. Examples of measurement gaps are measurement gap id #0 (each gap of 6 ms occurring every 40 ms), measurement gap id #1 (each gap of 6 ms occurring every 80 ms), etc. The measurement gaps are configured at the WD by the network node.

Generally, it may be considered that the network, e.g. a signaling radio node and/or node arrangement (e.g., network node), configures a WD, in particular with the transmission resources. A resource may in general be configured with one or more messages. Different resources may be configured with different messages, and/or with messages on different layers or layer combinations. The size of a resource may be represented in symbols and/or subcarriers and/or resource elements and/or physical resource blocks (depending on domain), and/or in number of bits it may carry, e.g. information or payload bits, or total number of bits. The set of resources, and/or the resources of the sets, may pertain to the same carrier and/or bandwidth part, and/or may be located in the same slot, or in neighboring slots.

In some embodiments, control information on one or more resources may be considered to be transmitted in a message having a specific format. A message may comprise or represent bits representing payload information and coding bits, e.g., for error coding.

Receiving (or obtaining) control information may comprise receiving one or more control information messages (e.g., scaling factor). It may be considered that receiving control signaling comprises demodulating and/or decoding and/or detecting, e.g. blind detection of, one or more messages, in particular a message carried by the control signaling, e.g. based on an assumed set of resources, which may be searched and/or listened for the control information. It may be assumed that both sides of the communication are aware of the configurations, and may determine the set of resources, e.g. based on the reference size.

Signaling may generally comprise one or more symbols and/or signals and/or messages. A signal may comprise or represent one or more bits. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different signaling processes, e.g. representing and/or pertaining to one or more such processes and/or corresponding information. An indication may comprise signaling, and/or a plurality of signals and/or messages and/or may be comprised therein, which may be transmitted on different carriers and/or be associated to different acknowledgement signaling processes, e.g. representing and/or pertaining to one or more such processes. Signaling associated to a channel may be transmitted such that represents signaling and/or information for that channel, and/or that the signaling is interpreted by the transmitter and/or receiver to belong to that channel. Such signaling may generally comply with transmission parameters and/or format/s for the channel.

An indication (e.g., an indication of scaling factor, etc.) generally may explicitly and/or implicitly indicate the information it represents and/or indicates. Implicit indication may for example be based on position and/or resource used for transmission. Explicit indication may for example be based on a parametrization with one or more parameters, and/or one or more index or indices corresponding to a table, and/or one or more bit patterns representing the information.

### Configuring a Radio Node

Configuring a radio node, in particular a terminal or user equipment or the WD, may refer to the radio node being adapted or caused or set and/or instructed to operate according to the configuration. Configuring may be done by another device, e.g., a network node (for example, a radio node of the network like a base station or gNodeB) or network, in which case it may comprise transmitting configuration data to the radio node to be configured. Such configuration data may represent the configuration to be configured and/or comprise one or more instruction pertaining to a configuration, e.g. a configuration for transmitting and/or receiving on allocated resources, in particular frequency resources, or e.g., configuration for performing certain measurements on certain subframes or radio resources. A radio node may configure itself, e.g., based on configuration data received from a network or network node. A network node may use, and/or be adapted to use, its circuitry/ies for configuring. Allocation information may be considered a form of configuration data. Configuration data may comprise and/or be represented by configuration information, and/or one or more corresponding indications and/or message/s.

### Configuring in General

Generally, configuring may include determining configuration data representing the configuration and providing, e.g. transmitting, it to one or more other nodes (parallel and/or sequentially), which may transmit it further to the radio node (or another node, which may be repeated until it reaches the wireless device). Alternatively, or additionally, configuring a radio node, e.g., by a network node or other device, may include receiving configuration data and/or data pertaining to configuration data, e.g., from another node like a network node, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g., an X2 interface in the case of LTE or a corresponding interface for NR. Configuring a terminal (e.g. WD) may comprise scheduling downlink and/or uplink transmissions for the terminal, e.g. downlink data and/or downlink control signaling and/or DCI and/or uplink control or data or communication signaling, in particular acknowledgement signaling, and/or configuring resources and/or a resource pool therefor. In particular, configuring a terminal (e.g. WD) may comprise configuring the WD to perform certain measurements on certain subframes or radio resources and reporting such measurements according to embodiments of the present disclosure.

A cell may be generally a communication cell, e.g., of a cellular or mobile communication network, provided by a node. A serving cell may be a cell on or via which a network node (the node providing or associated to the cell, e.g., base station or gNodeB) transmits and/or may transmit data (which may be data other than broadcast data) to a user equipment, in particular control and/or user or payload data, and/or via or on which a user equipment transmits and/or may transmit data to the node; a serving cell may be a cell for or on which the user equipment is configured and/or to which it is synchronized and/or has performed an access procedure, e.g., a random access procedure, and/or in relation to which it is in a RRC_connected or RRC_idle state, e.g., in case the node and/or user equipment and/or network follow the LTE and/or NR-standard. One or more carriers (e.g., uplink and/or downlink carrier/s and/or a carrier for both uplink and downlink) may be associated to a cell.

Predefined in the context of this disclosure may refer to the related information being defined for example in a standard, and/or being available without specific configuration from a network or network node, e.g. stored in memory, for example independent of being configured. Configured or configurable may be considered to pertain to the corresponding information being set/configured, e.g. by the network or a network node.

In some embodiments, the term “obtain” or “obtaining” is used herein and may indicate obtaining in e.g., memory such as in the case where the information is predefined or preconfigured or in the case where a network node or WD obtains the information from memory in order to transmit to another node/device. The term “obtain” or “obtaining” as used herein may also indicate obtaining by receiving signaling indicating the information obtained.

A physical channel is a channel of a physical layer that transmits a modulation symbol obtained by modulating at least one coded bit stream. An Orthogonal Frequency Division Multiple Access (OFDMA) system generates and transmits multiple physical channels according to the use of a transmission information stream or the receiver. A transmitter and a receiver should previously agree on the rule for determining for which REs the transmitter and receiver will arrange one physical channel during transmission on the REs, and this rule may be called ‘mapping’.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

In some embodiments, the general description elements in the form of “one of A and B” corresponds to A or B. In some embodiments, at least one of A and B corresponds to A, B or AB, or to one or more of A and B. In some embodiments, at least one of A, B and C corresponds to one or more of A, B and C, and/or A, B, C or a combination thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide arrangements for measurements scaling for measurement gap in NTN.

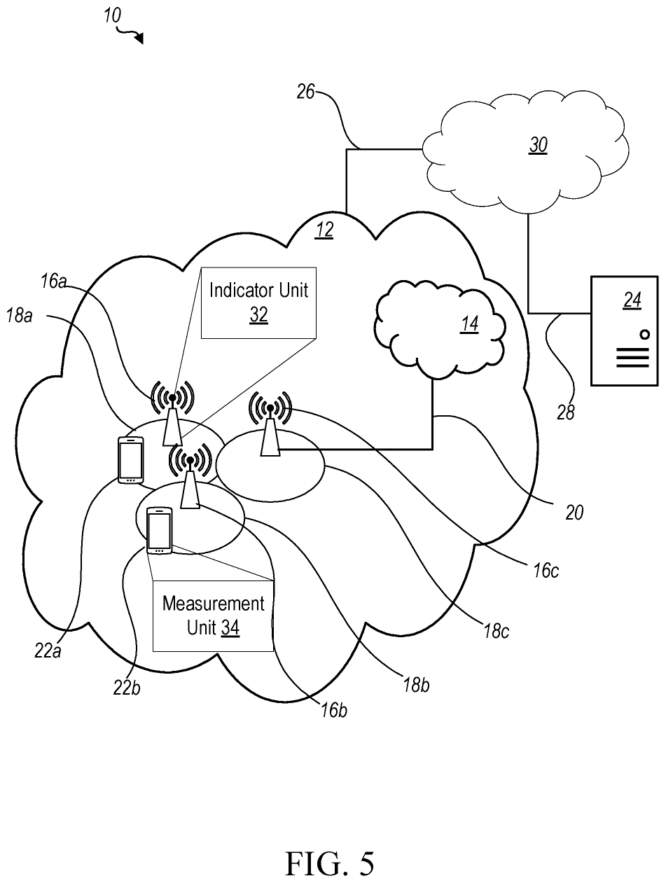

Referring again to the drawing figures, in which like elements are referred to by like reference numerals, there is shown in FIG. 5 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 5 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include an indication unit 32 which is configured to perform any step and/or task and/or process and/or method and/or feature described in the present disclosure, e.g., obtain an indication of a scaling factor for a measurement gap; and receive information about a measurement, the measurement being based on the scaling factor.

A wireless device 22 is configured to include a measurement unit 34 which is configured to perform any step and/or task and/or process and/or method and/or feature described in the present disclosure, e.g., obtain an indication of a scaling factor for a measurement gap (MG); and perform a measurement based on the scaling factor.

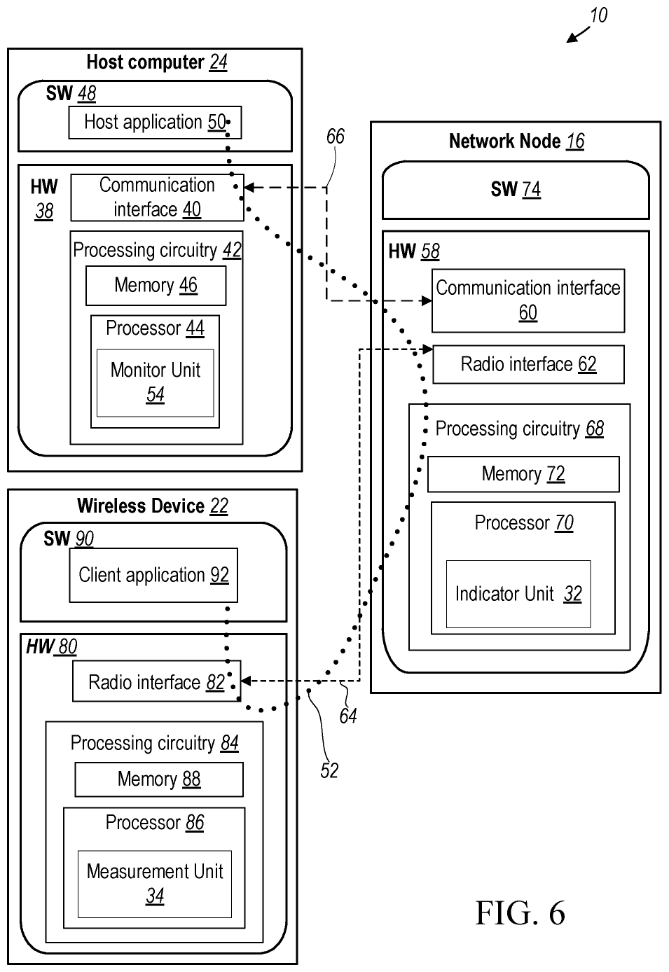

Example implementations, in accordance with an embodiment, of the WD 22, network node 16 and host computer 24 discussed in the preceding paragraphs will now be described with reference to FIG. 6. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22. The processing circuitry 42 of the host computer 24 may include a monitor unit 54 configured to enable the service provider to observe, monitor, control, transmit to and/or receive from the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include indicator unit 32 configured to perform any step and/or task and/or process and/or method and/or feature described in the present disclosure, e.g., perform network node methods discussed herein.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a measurement unit 34 configured to perform any step and/or task and/or process and/or method and/or feature described in the present disclosure, e.g., perform WD methods discussed herein.

In some embodiments, the inner workings of the network node 16, WD 22, and host computer 24 may be as shown in FIG. 6 and independently, the surrounding network topology may be that of FIG. 5.

In FIG. 6, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 5 and 6 show various “units” such as indication unit 32, and measurement unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

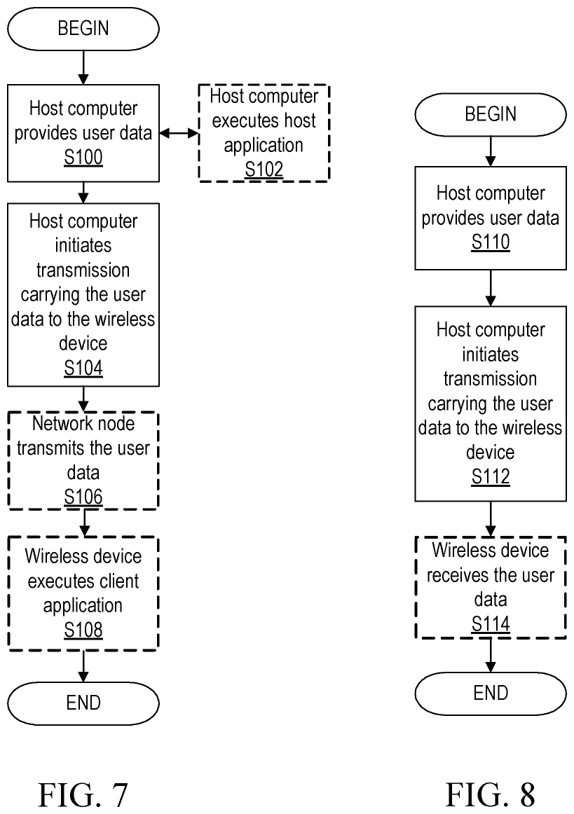

FIG. 7 is a flowchart illustrating an example method implemented in a communication system, such as, for example, the communication system of FIGS. 5 and 6, in accordance with one embodiment. The communication system may include a host computer 24, a network node 16 and a WD 22, which may be those described with reference to FIG. 6. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 8 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

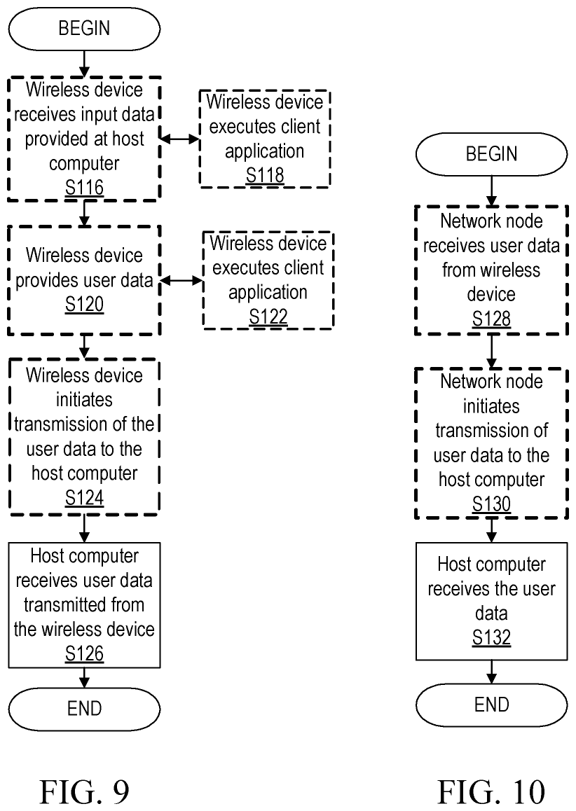

FIG. 9 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 10 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

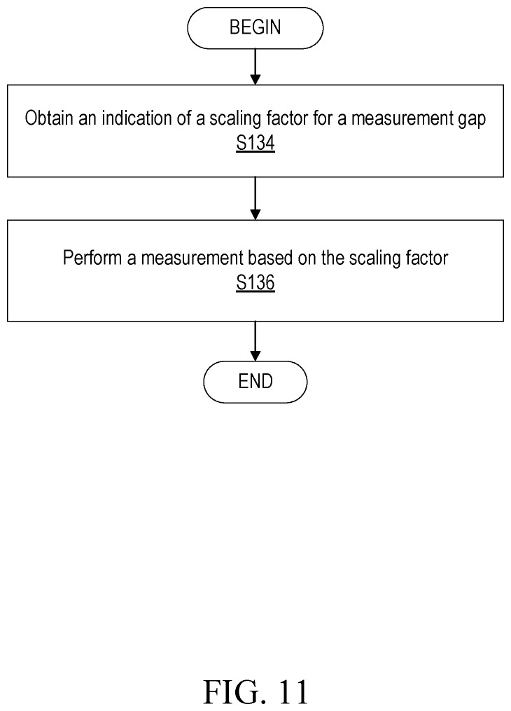

FIG. 11 is a flowchart of an example process in a wireless device 22 according to some embodiments of the present disclosure. One or more Blocks and/or functions and/or methods performed by WD 22 may be performed by one or more elements of WD 22 such as by measurement unit 34 in processing circuitry 84, processor 86, radio interface 82, etc. The WD 22 is configured to obtain (Block S134) an indication of a scaling factor for a measurement gap (MG). The WD 22 is configured to perform (Block S136) a measurement based on the scaling factor.

In some embodiments, at least one of: the network node is a non-terrestrial network node (NTN); the scaling factor is at least one of: based on at least one signal reception proximity (SRP) condition; associated with at least one of: a priority indication, a de-prioritized indication, an activation indication, a de-activation indication, an enabled indication, a disabled indication and a dropped indication; based on a pre-defined rule; and indicated as a part and/or proportion of a shared measurement gap pattern (MGP); and the shared MGP comprises at least one of: a plurality of at least partially overlapping MGs; and a first MPG and a second MPG having a different at least one of: scaling factor and/or parameter associated with the scaling factor comprising gap repetition periodicity, gap length, SMTC configuration parameter and SRP condition.

In some embodiments, the WD 22 is configured to, such as by measurement unit 34 in processing circuitry 84, processor 86 and/or radio interface 82, send information about the measurement to the network node; and receive an indication to modify the scaling factor and/or a parameter associated with the scaling factor based at least in part on the information about the measurement.

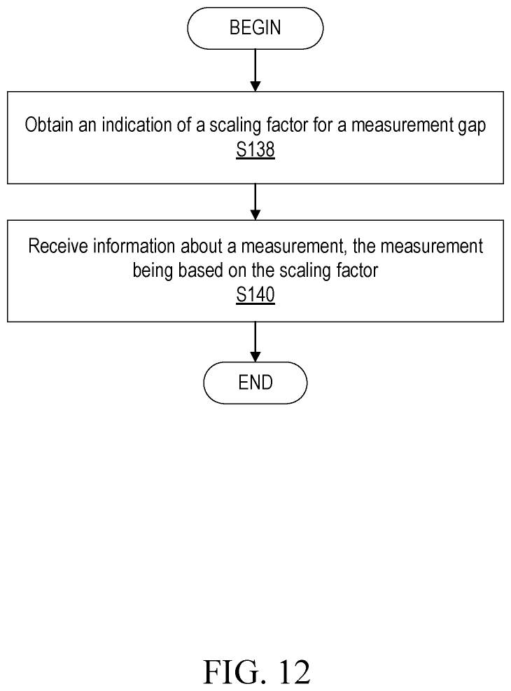

FIG. 12 is a flowchart of an example process in a network node 16 (e.g., a network node associated with a satellite) according to some embodiments of the present disclosure. One or more Blocks and/or functions and/or methods performed by the network node 16 may be performed by one or more elements of network node 16 such as by indication unit 32 in processing circuitry 68, processor 70, communication interface 60, radio interface 62, etc. according to the example method. The network node 16 is configured to obtain (Block S138) an indication of a scaling factor for a measurement gap. The network node 16 is configured to receive (Block S140) information about a measurement, the measurement being based on the scaling factor.

In some embodiments, at least one of: the network node is a non-terrestrial network node (NTN); the scaling factor is at least one of: based on at least one signal reception proximity (SRP) condition; associated with at least one of: a priority indication, a de-prioritized indication, an activation indication, a de-activation indication, an enabled indication, a disabled indication and a dropped indication; based on a pre-defined rule; and indicated as a part and/or proportion of a shared measurement gap pattern (MGP); and the shared MGP comprises at least one of: a plurality of at least partially overlapping MGs; and a first MPG and a second MPG having a different at least one of: scaling factor and/or parameter associated with the scaling factor comprising gap repetition periodicity, gap length, SMTC configuration parameter and SRP condition.

In some embodiments, network node 16 is configured to, such as by indication unit 32 in processing circuitry 68, processor 70, communication interface 60 and/or radio interface 62, send an indication to modify the scaling factor and/or a parameter associated with the scaling factor based at least in part on the information about the measurement.

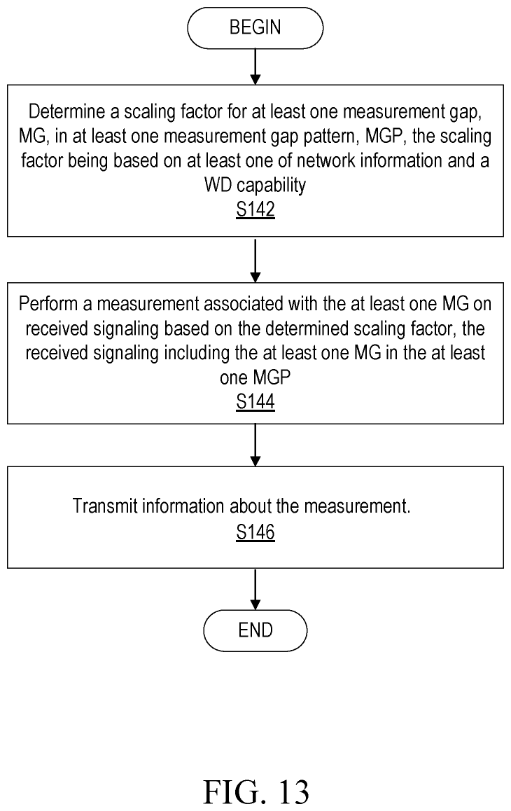

FIG. 13 is a flowchart of an example process in a wireless device 22 according to some embodiments of the present disclosure. One or more Blocks and/or functions and/or methods performed by WD 22 may be performed by one or more elements of WD 22 such as by measurement unit 34 in processing circuitry 84, processor 86, radio interface 82, etc. The WD 22 is configured to determine (Block S142) a scaling factor for at least one measurement gap (MG) in at least one measurement gap pattern (MGP), where the scaling factor is based on at least one of network information and a WD capability; perform (Block S144) a measurement associated with the at least one MG on received signaling (e.g., transmitted by a network node) based on the determined scaling factor, where the received signaling includes the at least one MG in the at least one MGP; and transmit (Block S146) information about the measurement.

In some embodiments, the at least one MGP meets at least one signal reception proximity (SRP) condition of at least one of a first plurality of SRP conditions, a second plurality of SRP conditions, and a third plurality of SRP conditions.

In some other embodiments, the first plurality of SRP conditions includes: a first difference (T11−T21) between a first starting point (T11) and a second starting point (T21) in time of corresponding gaps (e.g., measurement gaps, measurement gap occasions, etc.) of the at least one MGP is within a first time duration (Δ; a second difference (T11−T22) between the first starting point (T11) of a first gap in a first MGP of the at least one MGP and a first ending point (T22) in time of a second gap in a second MGP of the at least one MGP is within a second time duration (α; and a third difference (T12−T21) between a second ending point (T12) in time of the first gap in the first MGP and the second starting point in time (T21) of the second gap in the second MGP is within a third time duration (β). At least one of the first, second, and third differences is a time difference.

In an embodiment, the second plurality of SRP conditions includes the first difference (T11−T21) is greater than a fourth time duration (Δ1) but less than a fifth time duration (Δ2); the second difference (T11−T22) is greater than a sixth time duration (α1) but smaller than a seventh time duration (α2); and the third difference (T12−T21) is greater than an eight time duration (β1) but less than a ninth time duration (β2).

In another embodiment, the third plurality of SRP conditions includes: the first difference (T11−T21) is greater than a tenth time duration (Δa); the second difference (T11−T22) is greater than an eleventh time duration (αa); and the third difference (T12−T21) is greater than a twelfth time duration (βa).

In some embodiments at least one of the scaling factor triggers one of an equal measurement opportunity and an unequal measurement opportunity for the measurement to be performed among one or more MGs having different priority; and the scaling factor indicates a proportion of MGs between at least two MGs of the at least one MG. The proportion of MGs may refer to one or more percentage each MG occupies, how much an MG1 is measured, and how much another MG2 is measured such as based on a ratio between MG1 and MG2. The proportion may be predetermined using a predefined rule.

In some other embodiments, one of the method further includes receiving an indication of the scaling factor from the network node; and the scaling factor is pre-configured in the WD.

In an embodiment, at least one of the indication of the scaling factor indicates at least one of activated and deactivated MGs of the at least one MG; and the at least one of activated and deactivated MGs meets at least one SRP condition (e.g., if two MGs meet SRP, then one MG may be deactivated.

In another embodiment, at least one of the network node 16 is a non-terrestrial network node (NTN); the at least one MG is received by the WD 22 at a reception time based on a propagation delay associated with the NTN; and the scaling factor triggers the WD 22 to at least one of perform the measurement associated with the at least one MG at a measurement time corresponding to the reception time and transmit information about the measurement, where the information about the measurement is usable by the network node to update the scaling factor

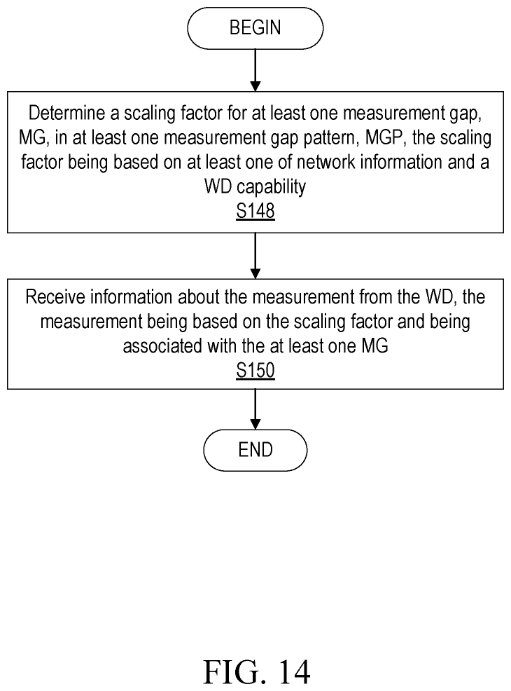

FIG. 14 is a flowchart of an example process in a network node 16 (e.g., a network node associated with a satellite) according to some embodiments of the present disclosure. One or more Blocks and/or functions and/or methods performed by the network node 16 may be performed by one or more elements of network node 16 such as by indication unit 32 in processing circuitry 68, processor 70, communication interface 60, radio interface 62, etc. according to the example method. The network node 16 is configured to determine (Block S148) a scaling factor for at least one measurement gap (MG) in at least one measurement gap pattern (MGP), where the scaling factor is based on at least one of network information and a WD capability; and receive (Block S150) information about the measurement from the WD, the measurement being based on the scaling factor and being associated with the at least one MG.

In some embodiments, the at least one MGP meets at least one signal reception proximity (SRP) condition of at least one of a first plurality of SRP conditions, a second plurality of SRP conditions, and a third plurality of SRP conditions.

In some other embodiments, the first plurality of SRP conditions includes a first difference (T11−T21) between a first starting point (T11) and a second starting point (T21) in time of corresponding gaps of the at least one MGP is within a first time duration (Δ); a second difference (T11−T22) between the first starting point (T11) of a first gap in a first MGP of the at least one MGP and a first ending point (T22) in time of a second gap in a second MGP of the at least one MGP is within a second time duration (α); and a third difference (T12−T21) between a second ending point (T12) in time of the first gap in the first MGP and the second starting point in time (T21) of the second gap in the second MGP is within a third time duration (β).

In an embodiment, the second plurality of SRP conditions includes the first difference (T11−T21) is greater than a fourth time duration (Δ1) but less than a fifth time duration (Δ2); the second difference (T11−T22) is greater than a sixth time duration (α1) but smaller than a seventh time duration (α2); and the third difference (T12−T21) is greater than an eight time duration (β1) but less than a ninth time duration (02).

In another embodiment, the third plurality of SRP conditions includes the first difference (T11−T21) is greater than a tenth time duration (Δa); the second difference (T11−T22) is greater than an eleventh time duration (αa); and the third difference (T12−T21) is greater than a twelfth time duration (βa).

In some embodiments, at least one of the scaling factor triggers one of an equal measurement opportunity and an unequal measurement opportunity for the measurement to be performed among one or more MGs having different priority; and the scaling factor indicates a proportion of MGs between at least two MGs of the at least one MG.

In some other embodiments, one of the method further includes transmitting an indication of the scaling factor to the WD 22; and the scaling factor is pre-configured in the WD 22.

In an embodiment, at least one of the indication of the scaling factor indicates at least one of activated and deactivated MGs of the at least one MG; and the at least one of activated and deactivated MGs meets at least one SRP condition.

In another embodiment, at least one of the network node 16 is a non-terrestrial network node (NTN); the at least one MG is received by the WD 22 at a reception time based on a propagation delay associated with the NTN; and the scaling factor triggers the WD 22 to at least one of perform the measurement associated with the at least one MG at a measurement time corresponding to the reception time and transmit information about the measurement; and the method further includes updating the scaling factor based on the information about the measurement.

Having described the general process flow of arrangements of the disclosure and having provided examples of hardware and software arrangements for implementing the processes and functions of the disclosure, the sections below provide details and examples of arrangements for measurements scaling for measurement gap in NTN, which may be implemented by the network node 16, wireless device 22 and/or host computer 24. For example, one or more network node 16 functions described below may be performed by one or more of processing circuitry 68, processor 70, indicator unit 32, etc. One or more wireless device 22 functions described below may be performed by one or more of processing circuitry 84, processor 86, measurement unit 34, etc.

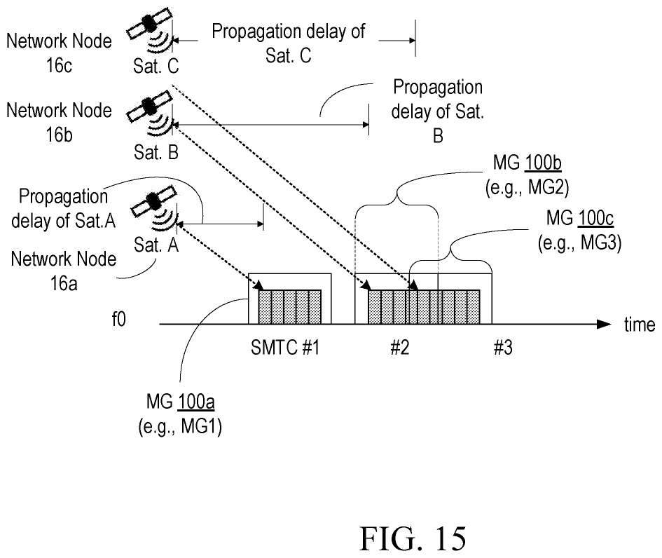

Multiple SMTC/MG configurations are enabled by introducing different new offsets. FIG. 15 shows one or more MGs 100 (e.g., MG 100a such as MG1, MG 100b such as MG2, MG 100c such as MG3). As depicted in FIG. 15, SMTC/MG1 and SMTC/MG2 are not overlapped, SMTC/MG 2 and SMTC/MG3 are overlapped, at least partly. In other words, there is an overlap proportion of at least two MGs 100 (e.g., a part of SMTC/MG 2 and SMTC/MG3 that overlap with respect to another part of at least one of SMTC/MG 2 and SMTC/MG3 that does not overlap). In some embodiments, the overlap proportion is a ratio of the part of SMTC/MG 2 and SMTC/MG3 that overlap with respect to another part of at least one of SMTC/MG 2 and SMTC/MG3 that does not overlap. Although SMTC/MG 2 and SMTC/MG3 have been described as overlapping and to describe overlap proportion, the embodiments of the present disclosure are not limited as such, and any SMTC and/or MG and/or any resource may overlap and be associated with an overlap proportion. In view of the above-described problem, a scaling WD 22 measurement procedure is described herein, e.g., in order to save WD 22 power (e.g. energy, battery life etc.) and/or avoid or minimize signaling overhead and/or minimize interruption due to link changes e.g. interruptions due to cell change (e.g. handover/HO), BM (e.g. beam changes etc.).

The term operation of a signal may comprise transmission of the signal by the WD 22 and/or reception of the signal at the WD 22.

The method in WD 22 comprises, WD 22 adapting the operation of one or more signals with respect to the scaling solutions, which may indicate measurements are not in each MG always mandatorily.

In one example, the measurement adaptation or adaptive measurement or adaptive measurement procedure enables the WD 22, while maintaining the connection with satellite, to measure on signals with different rate and/or periodicity and/or over different time period in certain radio resource control (RRC) state, e.g., in RRC IDLE and RRC INACTIVE procedures. In another example, the monitoring adaptation or adaptive monitoring or adaptive monitoring procedure enables the WD 22 to monitor a downlink control channel, (e.g. for example for paging, acquiring system information etc.), while maintaining the connection with satellite, less frequently (e.g., monitoring less frequently than traditional systems).

One embodiment may include a scaling sharing solution for MG which provides sharing factor (and/or scaling factor) between consecutive MGs.

One or more MGs 100 can be categorized as a MG set 102. The term “set” may refer to a union, a group, comprising one or more set elements, and/or any other wording to express the MGs in the set may be treated as combination of the MGs in the set.
Accordingly, an example of MG set Y may comprise MG_Y1, MG_Y2, MG_Y3, etc.
Accordingly, an example of MG set Z comprise MG_Z1, MG_Z2, MG_Z3, etc., and MG set Y1, MG set Y2, MG set Y3, etc.

In one example, the gap set can be exclusive for all the configured MGs 100. One or more MGs 100 and one or more MG sets 102 can be categorized as multi-level of MG sets 102.
If all items in one MG set 102 are single MGs 100 without any MG set 102, the MG 100 is level 1.
In one MG set 102, if the highest level of component MG set 102 is level N, then the MG 100 is level N+1.
A rule to group the MGs 100 into one MG set 102 can be as follows:
The magnitude of the difference between two MGs 100 meets one or more conditions such as SRP1 or SRP2;
More than two MGs 100,
   if the magnitude of the difference between the starting points in time of the first gap and last gap meet the SRP1 or SRP2.
   if the magnitude of the difference between the starting point in time of the gap in a first MGP and the ending point in time of the gap in a last MGP 100b meet the SRP1 or SRP2.
   if the magnitude of the difference between the ending point in time of the gap in a first MGP and the starting point in time of the gap in a last MGP meet the SRP1 or SRP2.
NN 16 can indicate the MGs 100 in one MG set 102 based on MO priority or MG priority or indication/suggestion by WD 22 or up to NN 16 implementation.

In some embodiments, priority or measurement priority or MG priority is a term which is associated with the measurement frequency, rate or samples on one MG by WD 22. For example, higher priority on one MG 100 may refer to a measurement frequency or rate that is higher or more measurement samples in one time period.

Further, lower priority on one MG 100 may refer to a measurement frequency or rate is lower or fewer measurement samples in one time period. The term of level of MG is adopted to indicate priority of MG 100, e.g., level 2 MG 100 has higher priority than level 1 MG 100.

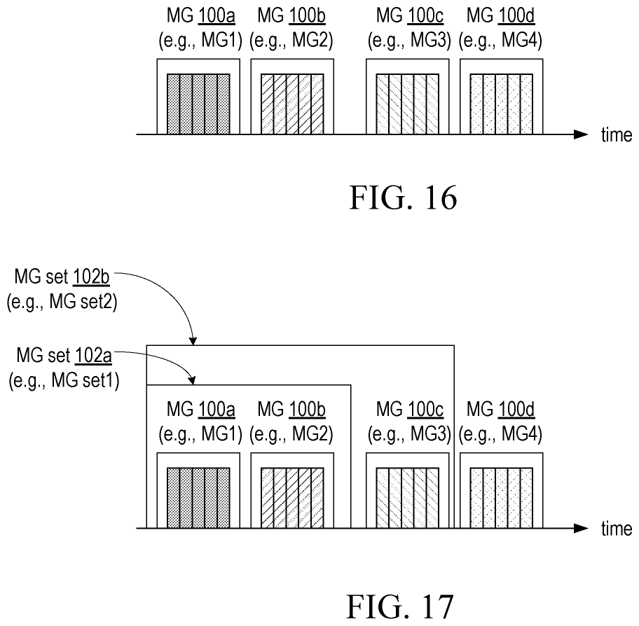

In some other embodiments, one or more example MGs 100 may be categorized. FIG. 16 shows four MGs 100 (e.g., MG 100a such as MG1, MG 100b such as MG2, MG 100c such as MG3, MG 100d such as MG4) categorized with different level of MG sets. FIG. 17 shows an example of a multi-SMTC scenario. More specifically:
MG1+MG2=MG set1; where MG1 and MG2 are at same level 1;
MG set1+MG3=MG set2. where MG set1 and MG3 are at same level 2;
MG set2 and MG4 are at same level 3.

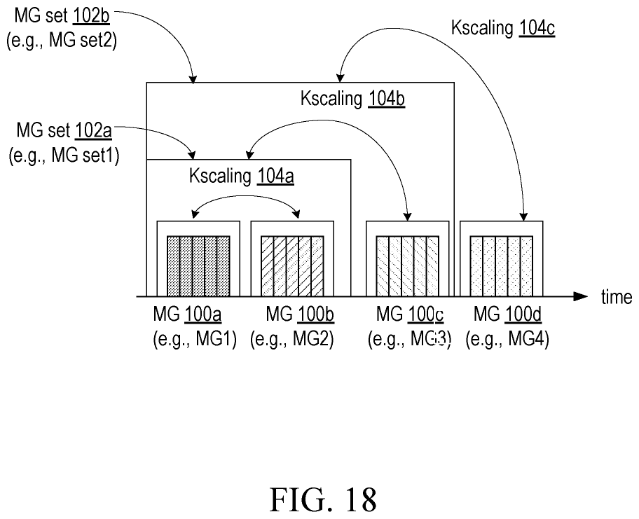

The measurement delay requirement for each measurement satellite or cell per frequency layer is expressed by a general function as follows:
Tmeas=f1(Ksharing, SMTC period, DRX cycle), where,
Kscaling104 (e.g., Kscaling 104a, Kscaling 104b, Kscaling 104c shown at least on FIG. 18) is a scaling/sharing factor or a set or sets of a scaling/sharing factor.

If Kscaling=M, WD 22 may operate measurement the MG per f2(M) occasions/periodicity based on SMTC period, DRX cycle.

Where f2 is formula involving M to calculate exact number.

In an example, Kscaling=1, WD 22 may operate measurement per 1 MG occasions/periodicity. In another example, Kscaling=2, WD 22 may operate measurement per 2 MG occasions/periodicity. In another example, Kscaling=0, WD 22 may skip or ignore measurement the MG.

Kscaling 104 can be cascaded from 1 stage up to N stages to cover each or several level of MG and MG sets.

For a MG, the generation of Kscaling by multi-stage can be expressed as:
Kscaling=f3(Kscaling1), for only one stage
Kscaling=f4(Kscaling1, Kscaling2), for two stages
Kscaling=f5(Kscaling1, Kscaling2, Kscaling3 . . . KscalingN), for N stages.

To scale each MG flexibly, the mapping between cascading Kscaling and MG sets are expressed as following:
KscalingX may scale MG setsY and MGs and MG sets which level is lower than Y, where X is stage index of scaling and Y is level of set.
KscalingX+1 may scale MG setsY+1 and MGs and MG sets which level is lower than Y+1, and so on.
Generally, KscalingX+AX may scale MG setsY+ΔY and MGs and MG sets which level is lower than Y+ΔY, where AX can be equal or inequal to ΔY. FIG. 18 illustrates an example MG set and cascading Kscaling 104. Taking FIG. 18 as example, the mapping relationship is:
Kscaling 104a (e.g., Kscaling1) is a scaling sharing (e.g., scaling factor) between MGs 100a, 100b (e.g., MG1 and MG2, respectively), because MG1 and MG2 are the same at level 1.
Kscaling 104b (e.g., Kscaling2) is a scaling sharing between MG 102a (e.g., MG set1) and MG 100c (e.g., MG3), because MG set 102a (e.g., MG set1) and MG 100c (e.g., MG3) are the same at level 2.
Kscaling 104c (e.g., Kscaling3) is a scaling sharing between MG set 102b (e.g., MG set2) and MG 100d (e.g., MG4), because MG set 102b (e.g., MG set2) and MG 100d (e.g., MG4) are the same at level 3.

Following the above mapping, each MG 100 can get its scaling factor. For example:
For MGs 100a, 100b (MG1 and MG2), Kscaling 104 can be defined as: Kscaling1=1; Kscaling2=1; Kscaling3=2. It implies WD 22 may perform measurements in MG1 1 time per Kscaling=Kscaling1*Kscaling2*Kscaling3=1*1*1=1 occasions/periodicities.
For MG 100c (e.g., MG3), Kscaling 104 can be defined as: Kscaling2=1; Kscaling3=1. It implies WD 22 may perform measurements in MG3 1 time per Kscaling=Kscaling2*Kscaling3=1*1=1 occasions/periodicities.
For MG 100d (e.g., MG4), Kscaling 104 can be defined as: Kscaling3=1. It implies WD 22 may perform measurements in MG4 1 time per Kscaling=*Kscaling3=1 occasions/periodicities.

It may be noted that the format can be various in implementation, but the format target may indicate which Kscaling and Kscaling stage the MG may utilize to get scaling factor.

It may be noted that the MG set 1002 and cascading Kscaling 104 can be any combinations among MGs 100, e.g., not always like the sequence shown in FIG. 16, in which MGs 100 may not be consecutive to combine a MG set 102. From a definition-and-utilization perspective, the mapping between an MG set 102 and cascading Kscaling 104 is flexible.

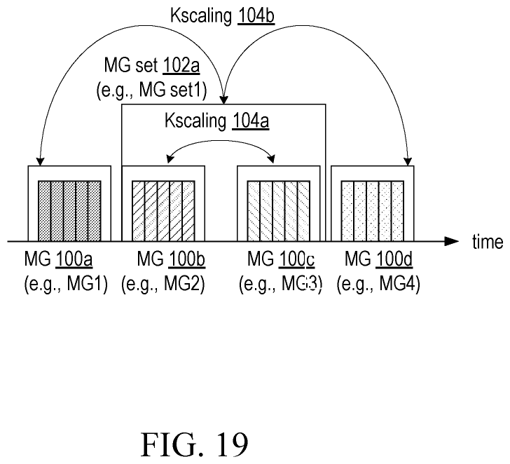

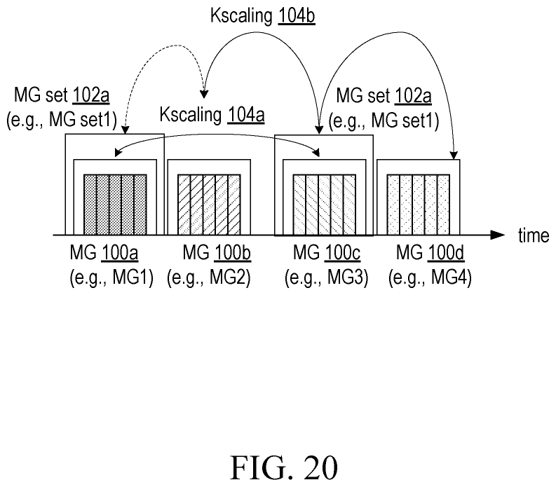

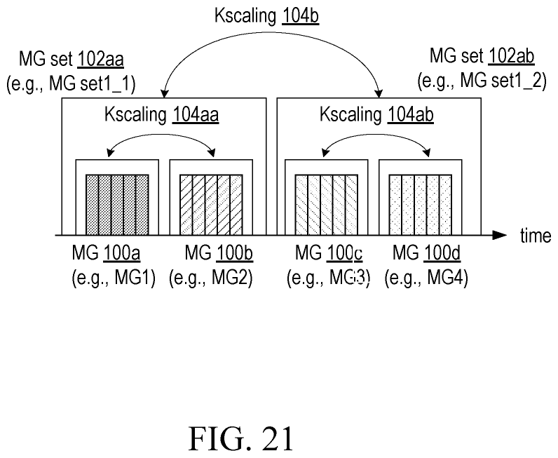

FIGS. 19-21 illustrate examples of other example instances of at least one MG set 102 and at least one cascading Kscaling 104.

It may be noted that if MGs 100 or MGs set 102 meet SRP1 or SRP2, the scaling factor of those MGs 100 or MGs sets 102 may be more than 1. Further, MGs 100 or MG sets 102 which meet SRP1 or SRP2 may be scaled.

The example shown in at least one of FIGS. 19-21 shows a possibility that MG1 and MG2 meet SRP1 or SRP2. In this case, Kscaling1 cannot be set 1.
For MG1 and MG2, Kscaling can be defined as this format: Kscaling1=2; Kscaling2=1; Kscaling3=1. It implies MG1 may be measured 1 time per Kscaling=Kscaling1*Kscaling2*Kscaling3=2*1*1=2 occasions/periodicities.

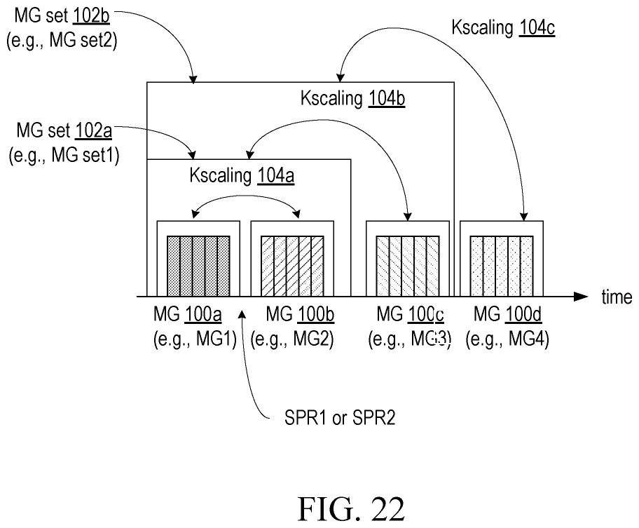

FIG. 22 illustrates an example MG set and cascading Kscaling with meets SRP1 or SRP2.

An equal scaling scheme indicate all Kscaling of all MGs are same.

An inequal scaling scheme indicate all Kscaling of all MGs are not same.

Equal scaling or unequal scaling scheme is configurable (e.g., at the WD 22) and/or signalable by the network node 16. In some embodiments, the scheme is based on a pre-defined rule.
If a MG's KscalingX=A and another MG's KscalingX=B, the scaling scheme is inequal at stage X. In one example, if A=1 and B=0, then the MG associated with KscalingX=1 is measured each occasion, and the MG associated with KscalingX=0 is skipped or ignored by WD 22.
Due to mutli-stage of scaling factors and multi-level MGs, the equal scaling scheme or unequal scaling scheme can be treated as per stage/level or entirely.
If a MG's Kscaling=KscalingX(=A)*KscalingY(=B)=A*B and another MG's Kscaling=KscalingX(=B)*KscalingY(=A)=B*A, the scaling scheme is inequal at stage X or Y. but the scaling scheme is equal entirely.

### Regarding Equal Scaling Scheme:

In one specific example, Kscaling can be 1 if all the MGs meet the SRP3. It implies equal scaling opportunity because all MGs are measured per occasion/periodicity.

In another example, Kscaling can be N when the number of MGs is N and all MGs have equal sharing opportunity, e.g. for case with total 2 MGs: in first periodicity, measurement occurs in MG1; in second periodicity; measurement occurs in MG2; in third periodicity, measurement occurs in MG1 again, and so on.

### Regarding Inequal Scaling Scheme:

In one example, Kscaling can be different factors(Ni, i=1, 2, . . . ) when configured MGs have inequal sharing opportunity.

For example, when network configured total 3 MGs,
N1 for MG1
N2 for MG2
N3 for MG3

MG1 has higher priority in first periodicity, measurement occurs in MG1; in second periodicity; measurement occurs in MG1 and MG2; in third periodicity, measurement occurs in MG1 again, and so on. In this case, N1=1, N2=N3=2. The priority can be indicated by NN 16.

In another example, the NN 16 can transmit the signalling to WD 22 to indicate the percentage of each MG, where, X1+X2+X3+X4=100.

| MG1 (%) | MG2 (%) | MG3 (%) | MG4 (%) |
|---|---|---|---|
| Equal splitting | Equal splitting | Equal splitting | Equal splitting |
| X1 | X2 | X3 | X4 |

In another embodiment, scaling indication solution for MG provide sharing between consecutive MGs.

### Scaling Indication Solution 1

One embodiment of gap indication rule is that both NN 16 and WD 22 will have the clear understanding in each gap collision happens. An example is that network sends signaling of rule of indication to WD 22, accordingly network and WD 22 can sync. the scaling rule synchronously. In another example, the rule of adopting scaling indication is pre-defined, e.g., where network node 16 and WD 22 follow the pre-defined rule.
On the one hand, WD 22 can easily schedule the measurements based on the NN's 16 gap indication.
On the other hand, NN 16 can schedule the data on the unused gap occasion when collision happens.

It can be seen that there is uncertainty for WD's 22 behavior on each gap occasions for sharing rule. It means impossible to further utilize the gap instance which is not used for measurements by WD 22. On the contrary, after clear indication, data scheduling on the unused gap duration can be expected for gap indication rule.

Another aspect of the embodiment of gap indication has the benefits for flexible gap configuration. Setting priority on MG will always prioritize one gap when overlapping happens. However, if measurements are always prioritized for one gap, there is no benefits for configuring concurrent gaps. Compared with priority rule, indication rule and sharing rule can provide more flexibility and gap utilization.

Furthermore, gap indication rule is a general type of sharing rule and priority rule and can transform to sharing rule and priority rule easily.

An embodiment is that signaling by network comprises information how each MG is disable or enabled in different measurement occasion or periodicity.

An embodiment comprise WD 22 follows the signaling to setup measurements in MGs accordingly.

A specific example of the solution on gap collision for SRP3 is that a 4-bit map can be used as signaling content to define a gap indication rule as follow. NNs 16 can configure an indication map to WD 22 together with each gap to indicate the priority of this gap if a collision happens between gaps. Alternatively, the indication map is pre-defined and both network node 16 and WD 22 may perform one or more actions based on the indication map.
For example, indication index ‘0’ means the gap will be disabled, ‘1’ means the gap will be enabled. Assuming the indication index #8 i.e. signaling ‘1000’ is configured together with MG1, in the 1st measurement occasion or periodicity, the MG1 will be enable i.e. measurement occurs in MG1. In the 2nd-4th measurement occasions or periodicities, MG1 will be disabled i.e. no measurement in MG1.
After that, WD 22 will repeat the sequence. gap indication rule can be believed as a network-controlled gap sharing rule, in the other word, network knows and acknowledges which MGs are used and which MGs are not used accurately.

Indication index may refer to an identifier of certain indication rule for identification by network node 16 and/or WD 22.

It should be noted that the ‘first’ and ‘2nd-4th’ measurement occasions can refer to SFN or other approach that network and WD 22 can synchronize and account 4-bits map of MG repeatedly.

It should be noted that above is 4 bits map example, the bits number can be different in case of various number of MGs and configuration of MGs.

It should be noted that signaling may be defined as RRC parameters with optional medium access control (MAC) control element (CE) or downlink control information (DCI) indications, or other expressions.

It should be noted that the indication index and indication rule are not limited as such, the name and/or format may be different. However, the embodiment of the solution is the signaling by network node and/or a pre-defined rule comprises information about how each MG is disabled or enabled in different measurement occasions or for different periodicities.

TABLE 3
Scaling indication example

| Scaling indication | Indication rule |
|---|---|
| #0 | 0000 |
| #1 | 0001 |
| #2 | 0010 |
| #3 | 0011 |
| #4 | 0100 |
| #5 | 0101 |
| #6 | 0110 |
| #7 | 0111 |
| #8 | 1000 |
| #9 | 1001 |
| #10 | 1010 |
| #11 | 1011 |
| #12 | 1100 |
| #13 | 1101 |
| #14 | 1110 |
| #15 | 1111 |

A general example of scaling indication solution on gap collision for SRP1 and/or SRP2 is to add a limitation when 2 MGs meet SRP1 or SRP2.

Firstly, Table 3 can be spread to 2-D matrix. An example has 4 MGs is shown in Table 4. For each occasion, the signaling can be ‘1’ or ‘0’ and the full signaling of a MG is a 4-bits map.

TABLE 4
Signaling indication in occasions

| | Occasion1 | Occasion2 | Occasion3 | Occasion4 |
|---|---|---|---|---|
| MG1 | 1/0 | 1/0 | 1/0 | 1/0 |
| MG2 | 1/0 | 1/0 | 1/0 | 1/0 |
| MG3 | 1/0 | 1/0 | 1/0 | 1/0 |
| MG4 | 1/0 | 1/0 | 1/0 | 1/0 |

If MG1 and MG2 meet SRP1 or SRP2, then the indication index in occasions when they collide may follow different rule, for example:
In occasion1, indication index for MG1 is X, X can be ‘1’ or ‘0’, then indication index for MG2 is Y, Y can be ‘1’ or ‘0’; In some examples, X≠Y but not limited as such, e.g., where X and Y are ‘0’.
In occasion2, indication index for MG1 is Y(or X), Y(or X) can be ‘1’ or ‘0’, then indication index for MG2 is X(or Y if MG1 is X), X(or Y if MG1 is X) can be ‘1’ or ‘0’, In some examples, X≠Y but not limited as such, e.g., where X and Y are ‘0’.

That is, the full indication index of MG1 can be ‘1011’, and indication index of MG2 is ‘0111’.

TABLE 5
Scaling indication in occasions when meeting SRP1 and SRP2

| | Occasion1 | Occasion2 | Occasion3 | Occasion4 |
|---|---|---|---|---|
| MG1 | X | Y(X) | 1/0 | 1/0 |
| MG2 | Y | X(Y) | 1/0 | 1/0 |
| MG3 | 1/0 | 1/0 | 1/0 | 1/0 |
| MG4 | 1/0 | 1/0 | 1/0 | 1/0 |

### Scaling Indication Solution 2

Another alternative embodiment which can be used in SRP 1,2,3 is that a bit map can be used as signaling content to define a gap indication rule as follows. Network node 16 can configure an indication map to WD 22 together with one of the gaps to indicate whether to prioritize this gap if a collision happens between gaps. The indication map may be pre-defined, and the network node 16 and WD 22 may be configured to perform one or more action based on the indication map, e.g., WD 22 may repeat performing the measurements based on the order of the MG indication.
For example, ‘1’ means the MG1 will be enabled, ‘2’ means the MG2 will be enabled, ‘3’ means the gap MG3 will be enabled, ‘4’ means the gap index MG4 will be enabled.
After that, WD 22 will repeat the sequence. A gap indication rule may refer to a network-controlled gap sharing rule. In other words, network node 16 knows and acknowledges which MGs are used and which MGs are not used accurately.

In an embodiment, the scaling indication such as scaling ‘1234’ is configured. In another embodiment, equal sharing for all MGs may be implied. In some embodiments:
The WD 22 will perform measurements in MG1 in the first occasion/periodicity.
The WD 22 will perform measurements in MG2 in the second occasion/periodicity.
The WD 22 will perform measurements in MG3 in the third occasion/periodicity.
The WD 22 will perform measurements in MG4 in the fourth occasion/periodicity.

With respect to this embodiment, it should also be noted that the ‘first’ and ‘2nd-4th’ measurement occasions may refer to SFN or other approach such as where network node 16 and WD 22 can synchronize and take into account 4-bits map of MG repeatedly.

In one embodiment, such as where gap collision may meet at least one of SRP1 and SRP2,network node 16 can configure an indication map to WD 22 together with one of the gaps to indicate whether to prioritize this gap if a collision happens between gaps. For example, the collided MGs are MG1 and MG2, where ‘0’ means the gap will be disabled, and ‘1’ means the gap will be enabled. Assuming the indication index ‘1000’ is configured together with MG1, in the 1st gap collision occasion, the MG1 will be prioritized. In the 2nd-4th gap collision occasions, MG2 will be prioritized. After that, WD 22 will repeat the gap priority sequence. At the same time, indication rule implies priority (For example, only configures the indication index #0 or #15).

TABLE 6
Scaling indication transformation among three rules

| Indication index | Indication rule |
|---|---|
| #0 | 0000 |
| #1 | 0001 |
| #2 | 0010 |
| #3 | 0011 |
| #4 | 0100 |
| #5 | 0101 |
| #6 | 0110 |
| #7 | 0111 |
| #8 | 1000 |
| #9 | 1001 |
| #10 | 1010 |
| #11 | 1011 |
| #12 | 1100 |
| #13 | 1101 |
| #14 | 1110 |
| #15 | 1111 |

An aspect carried by the indication rule may be that, regarding some gap occasions being disabled, data scheduling on the disabled gap occasions is permitted since both NN 16 and WD 22 have the same understanding on which gap occasion may be disabled.

Different from legacy NR data scheduling issues due to missing MOs configuration, one of the important reasons for which the gap occasions may be indicated is to avoid the situation in which WD 22 cannot receive the DL or/and transmit the UL during a long period. Thus, data scheduling is expected on the dropping gap occasions and the exact framework of data scheduling may vary along with different cases of MG configurations in above.

The general gap indication rule may be used to determine which gap may be kept and what condition to apply the rule to.

The scaling sharing solution and/or scaling indication solution may be used in combination.

Taking FIG. 22 as a simple example, the four MGs 100 meet SRP3:

### Adaptive Scaling Solution

One embodiment comprises a mechanism where scaling solutions and/or parameters/configurations in the scaling solution can be adaptively changed by network node 16 implicitly or explicitly with conditions, e.g. RSRP, time, location which fulfill predefined criteria or threshold.

A set of conditions may be expressed by the following:
S1,S2 . . . Sn,K1,K2 . . . Kn=f2(T,L1,L2), where:
   S1,S2 . . . Kn are scaling solutions.
   K1,K2 . . . Kn are parameters/configurations in scaling solution.
   T is time or timer.
   L1 is location(s) of satellite(s).
   L2 is location of WD 22.
   f2 indication any evaluation and comparison procedure.
   Note that above characters may be not mandatory, i.e., they may be optional in different network scenarios.

An example is one neighbor cell satellite has better RSRP than another cell satellite, higher scaling priority, or more measurement in occasions, which can be configured for the neighbor cell satellite with better RSRP.

Another example is one neighbor cell is going to fly over WD 22, where the scaling priority may be higher or more measurement in occasions which can be configured more intensely.

Another embodiment comprises a mechanism where scaling solutions and/or parameters/configurations in a scaling solution can be adaptive, e.g., once network receives signaling of WD capacity/capability of handling different configurations of MGs 100.

For different WD 22, the capacity of handling different configurations of MGs is various. For example, FR2 WD 22 may use scaling solution for case 1 because its analog beamforming cannot process different inter-frequency measurements, especially when spatial information is different.

Another embodiment comprises a mechanism where configurations of MGs 100 can be adaptively changed by network node 16 once network node 16 receives signaling of WD capacity or choice of handling different scaling solutions.

An example is if WD 22 can support a scaling indication solution but not a scaling sharing solution, WD 22 may inform network node 16 its capacity. This way, network node 16 may arrange proper SMTC and MG configurations.

In some embodiments, the network node 16 may be configured to transmit signaling comprising at least one MG in at least one MGP based on a scaling factor and/or indication of the scaling factor and/or a WD capability and/or WD capability indication. The signaling may further comprise RRC signaling (e.g., measConfig) such as to represent a configuration of one or more MGs.

The following is a nonlimiting list of example embodiments:

1. A network node 16 configured to communicate with a wireless device, WD 22, the network node 16 configured to, and/or comprising a radio interface 62 and/or comprising processing circuitry 68 configured to:
obtain an indication of a scaling factor for a measurement gap; and
receive information about a measurement, the measurement being based on the scaling factor.

2. The network node 16 of Claim 1, wherein at least one of:
the network node 16 is a non-terrestrial network node, NTN;
the scaling factor is at least one of:
   based on at least one signal reception proximity, SRP, condition;
   associated with at least one of: a priority indication, a de-prioritized indication, an activation indication, a de-activation indication, an enabled indication, a disabled indication and a dropped indication;
   based on a pre-defined rule; and
   indicated as a part and/or proportion of a shared measurement gap pattern, MGP; and
the shared MGP comprises at least one of:
   a plurality of at least partially overlapping MGs; and
   a first MPG and a second MPG having a different at least one of: scaling factor and/or parameter associated with the scaling factor comprising gap repetition periodicity, gap length, SMTC configuration parameter and SRP condition.

3. The network node 16 of any one of Claims 1 and 2, wherein the network node 16 and/or the radio interface 62 and/or the processing circuitry 68 is configured to:
send an indication to modify the scaling factor and/or a parameter associated with the scaling factor based at least in part on the information about the measurement.

4. A method implemented in a network node 16, the method comprising:
obtaining an indication of a scaling factor for a measurement gap; and
receiving information about a measurement, the measurement being based on the scaling factor.

5. The method of Claim 4, wherein at least one of:
the network node 16 is a non-terrestrial network node, NTN;
the scaling factor is at least one of:
   based on at least one signal reception proximity, SRP, condition;
   associated with at least one of: a priority indication, a de-prioritized indication, an activation indication, a de-activation indication, an enabled indication, a disabled indication and a dropped indication;
   based on a pre-defined rule; and
   indicated as a part and/or proportion of a shared measurement gap pattern, MGP; and
the shared MGP comprises at least one of:
   a plurality of at least partially overlapping MGs; and
   a first MPG and a second MPG having a different at least one of: scaling factor and/or parameter associated with the scaling factor comprising gap repetition periodicity, gap length, SMTC configuration parameter and SRP condition.

6. The method of any one of Claims 4 and 5, further comprising:
sending an indication to modify the scaling factor and/or a parameter associated with the scaling factor based at least in part on the information about the measurement.

7. A wireless device, WD 22, configured to communicate with a network node 16, the WD 22 configured to, and/or comprising a radio interface 82 and/or processing circuitry 84 configured to:
obtain an indication of a scaling factor for a measurement gap, MG; and
perform a measurement based on the scaling factor.

8. The WD 22 of Claim 7, wherein at least one of:
the network node 16 is a non-terrestrial network node, NTN;
the scaling factor is at least one of:
   based on at least one signal reception proximity, SRP, condition;
   associated with at least one of: a priority indication, a de-prioritized indication, an activation indication, a de-activation indication, an enabled indication, a disabled indication and a dropped indication;
   based on a pre-defined rule; and
   indicated as a part and/or proportion of a shared measurement gap pattern, MGP; and
the shared MGP comprises at least one of:
   a plurality of at least partially overlapping MGs; and
   a first MPG and a second MPG having a different at least one of: scaling factor and/or parameter associated with the scaling factor comprising gap repetition periodicity, gap length, SMTC configuration parameter and SRP condition.

9. The WD 22 of any one of Claims 7 and 8, wherein the WD 22 and/or the radio interface 82 and/or the processing circuitry 84 is configured to:
send information about the measurement to the network node 16; and
receive an indication to modify the scaling factor and/or a parameter associated with the scaling factor based at least in part on the information about the measurement.

10. A method implemented in a wireless device, WD 22, the method comprising:
obtaining an indication of a scaling factor for a measurement gap, MG; and
performing a measurement based on the scaling factor.

11. The method of Claim 10, wherein at least one of:
the network node 16 is a non-terrestrial network node, NTN;
the scaling factor is at least one of:
   based on at least one signal reception proximity, SRP, condition;
   associated with at least one of: a priority indication, a de-prioritized indication, an activation indication, a de-activation indication, an enabled indication, a disabled indication and a dropped indication;
   based on a pre-defined rule; and
   indicated as a part and/or proportion of a shared measurement gap pattern, MGP; and
the shared MGP comprises at least one of:
   a plurality of at least partially overlapping MGs; and
   a first MPG and a second MPG having a different at least one of: scaling factor and/or parameter associated with the scaling factor comprising gap repetition periodicity, gap length, SMTC configuration parameter and SRP condition.

12. The method of any one of Claims 10 and 11, further comprising:
sending information about the measurement to the network node 16; and
receiving an indication to modify the scaling factor and/or a parameter associated with the scaling factor based at least in part on the information about the measurement.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| 3GPP | 3rd Generation Partnership Project |
| 5G | 5th Generation |
| BS | Base Station |
| CHO | Conditional Handover |
| eNB | Evolved NodeB (LTE base station) |
| GEO | Geostationary Orbit |
| gNB | Base station in NR. |
| GNSS | Global Navigation Satellite System |
| HO | Handover |
| LEO | Low Earth Orbit |
| LTE | Long Term Evolution |
| MAC | Medium Access Control |
| MG | Measurement Gap |
| NR | New Radio |
| NTN | Non-Terrestrial Network |
| RAT | Radio Access Technology |
| RRC | Radio Resource Control |
| RRM | Radio Resource Management |
| RS | Reference Signal |
| RSRP | Reference Signal Received Power |
| SMTC | SSB Measurement Timing Configuration |
| SNR | Signal to noise ratio |
| UE | User Equipment |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a wireless device, WD, configured to communicate with a network node, the method comprising:
determining a scaling factor for at least one measurement gap, MG, in at least one measurement gap pattern, MGP, the scaling factor being based on at least one of network information and a WD capability;
performing a measurement associated with the at least one MG on received signaling based on the determined scaling factor, the received signaling including the at least one MG in the at least one MGP; and
transmitting information about the measurement.

2. The method of claim 1, wherein the at least one MGP meets at least one signal reception proximity, SRP, condition of at least one of a first plurality of SRP conditions, a second plurality of SRP conditions, and a third plurality of SRP conditions.

3. The method of claim 2, wherein the first plurality of SRP conditions includes:
a first difference, T11−T21, between a first starting point, T11, and a second starting point, T21, in time of corresponding gaps of the at least one MGP is within a first time duration, Δ;
a second difference, T11−T22, between the first starting point, T11, of a first gap in a first MGP of the at least one MGP and a first ending point, T22, in time of a second gap in a second MGP of the at least one MGP is within a second time duration, α; and
a third difference, T12−T21, between a second ending point, T12, in time of the first gap in the first MGP and the second starting point in time, T21, of the second gap in the second MGP is within a third time duration, β.

4. The method of claim 3, wherein the second plurality of SRP conditions includes:
the first difference, T11−T21, is greater than a fourth time duration, Δ1, but less than a fifth time duration, Δ2;
the second difference, T11−T22, is greater than a sixth time duration, α1, but smaller than a seventh time duration, α2; and
the third difference, T12−T21, is greater than an eight time duration. β1, but less than a ninth time duration, β2.

5. The method of claim 3, wherein the third plurality of SRP conditions includes:
the first difference, T11−T21, is greater than a tenth time duration, Δa;
the second difference, T11−T22, is greater than an eleventh time duration, αa; and
the third difference, T12−T21, is greater than a twelfth time duration, βa.

6. The method of claim 1, wherein at least one of:
the scaling factor triggers one of an equal measurement opportunity and an unequal measurement opportunity for the measurement to be performed among one or more MGs having different priority; and
the scaling factor indicates a proportion of MGs between at least two MGs of the at least one MG.

7. The method of claim 1, wherein one of:
the method further includes receiving an indication of the scaling factor from the network node; and
the scaling factor is pre-configured in the WD.

8. The method of claim 7, wherein:
the indication of the scaling factor indicates at least one of the activated and deactivated MGs of the at least one MG; and
the at least one of the activated and deactivated MGs meets at least one SRP condition.

9. The method of claim 1, wherein at least one of:
the network node is a non-terrestrial network node, NTN;
the at least one MG is received by the WD at a reception time based on a propagation delay associated with the NTN; and
the scaling factor triggers the WD to at least one of perform the measurement associated with the at least one MG at a measurement time corresponding to the reception time and transmit information about the measurement, the information about the measurement being usable by the network node to update the scaling factor.

10. A wireless device, WD, configured to communicate with a network node, the WD comprising a radio interface and processing circuitry in communication with the radio interface:
the processing circuitry being configured to:
determine a scaling factor for at least one measurement gap, MG, in at least one measurement gap pattern, MGP, the scaling factor being based on at least one of network information and a WD capability;
perform a measurement associated with the at least one MG on received signaling based on the determined scaling factor, the received signaling including the at least one MG in the at least one MGP; and
the radio interface being configured to:
transmit information about the measurement.

11.-18. (canceled)

19. A method in a network node configured to communicate with a wireless device, WD, the method comprising:
determining a scaling factor for at least one measurement gap, MG, in at least one measurement gap pattern, MGP, the scaling factor being based on at least one of network information and a WD capability; and
receiving information about a measurement from the WD, the measurement being based on the scaling factor and being associated with the at least one MG.

20. The method of claim 19, wherein the at least one MGP meets at least one signal reception proximity, SRP, condition of at least one of a first plurality of SRP conditions, a second plurality of SRP conditions, and a third plurality of SRP conditions.

21. The method of claim 20, wherein the first plurality of SRP conditions includes:
a first difference, T11−T21, between a first starting point, T11, and a second starting point, T21, in time of corresponding gaps of the at least one MGP is within a first time duration, Δ;
a second difference, T11−T22, between the first starting point, T11, of a first gap in a first MGP of the at least one MGP and a first ending point, T22, in time of a second gap in a second MGP of the at least one MGP is within a second time duration, α; and
a third difference, T12−T21, between a second ending point, T12, in time of the first gap in the first MGP and the second starting point in time, T21, of the second gap in the second MGP is within a third time duration, β.

22. The method of claim 21, wherein the second plurality of SRP conditions includes:
the first difference, T11−T21, is greater than a fourth time duration, Δ1, but less than a fifth time duration, Δ2;
the second difference, T11−T22, is greater than a sixth time duration, α1, but smaller than a seventh time duration, α2; and
the third difference, T12−T21, is greater than an eight time duration. β1, but less than a ninth time duration, β2.

23. The method of claim 21, wherein the third plurality of SRP conditions includes:
the first difference, T11−T21, is greater than a tenth time duration, Δa;
the second difference, T11−T22, is greater than an eleventh time duration, αa; and
the third difference, T12−T21, is greater than a twelfth time duration, βa.

24. The method of claim 19, wherein at least one of:
the scaling factor triggers one of an equal measurement opportunity and an unequal measurement opportunity for the measurement to be performed among one or more MGs having different priority; and
the scaling factor indicates a proportion of MGs between at least two MGs of the at least one MG.

25. The method of claim 19, wherein one of:
the method further includes transmitting an indication of the scaling factor to the WD; and
the scaling factor is pre-configured in the WD.

26. The method of claim 25, wherein:
the indication of the scaling factor indicates at least one of activated and deactivated MGs of the at least one MG; and
the at least one of the activated and deactivated MGs meets at least one SRP condition.

27. The method of claim 19, wherein at least one of:
the network node is a non-terrestrial network node, NTN;
the at least one MG is received by the WD at a reception time based on a propagation delay associated with the NTN; and
the scaling factor triggers the WD to at least one of perform the measurement associated with the at least one MG at a measurement time corresponding to the reception time and transmit information about the measurement; and
the method further includes updating the scaling factor based on the information about the measurement.

28.-36. (canceled)
